(19) United States
(12) Patent Application Publication
(10) Pub. No.: US 2015/0145958 A1
(43) Pub. Date: May 28, 2015

(54) MULTI-LENS IMAGE CAPTURING APPARATUS

(71) Applicant: CANON KABUSHIKI KAISHA, Tokyo (JP)

(72) Inventor: Chiaki Inoue, Utsunomiya-shi (JP)

(21) Appl. No.: 14/547,492

(22) Filed: Nov. 19, 2014

(30) Foreign Application Priority Data
Nov. 22, 2013 (JP) 2013-241466
Nov. 27, 2013 (JP) 2013-244844

(51) Int. Cl. H04N 13/02; G03B 35/04

(52) U.S. Cl. CPC H04N 13/0235; G03B 35/04
USPC 348/46

(57) ABSTRACT

The multi-lens image capturing apparatus includes multiple imaging optical systems arranged such that their optical axes are separate from one another in a direction orthogonal to the optical axes, and an image capturing unit in which multiple image-capturing areas each performing image capturing of an object through a corresponding one of the imaging optical systems are provided. The multiple imaging optical systems include multiple first imaging optical systems each having a first field angle and at least one second imaging optical system having a second field angle wider than the first field angle. When viewed from a direction of the optical axes, the optical axis of the at least one second imaging optical system is located in a first area surrounded by lines connecting positions of the optical axes of the multiple first imaging optical systems.

### BACKGROUND OF THE INVENTION

1. Field of the Invention

The present invention relates to a multi-lens image capturing apparatus including multiple imaging optical systems and including image-capturing areas each performing image capturing (photoelectric conversion) of an object through the corresponding imaging optical system.

2. Description of the Related Art

Conventionally, multi-lens image capturing apparatuses have been proposed whose optical system is divided into multiple optical systems to realize miniaturization of the optical system. Such multi-lens image capturing apparatuses, which utilize a compound-eye structure of eyes of insects, have a configuration including as the optical system, for example, a lens array constituted by multiple lens units whose diameters and focal lengths are reduced so as to miniaturize the optical system.

However, it has been difficult to add, to the conventional multi-lens image capturing apparatuses, an optical zoom function of varying an image-capturing field angle by moving a lens which constitutes the optical system since such a configuration invites an increase in size of the apparatus. To overcome this difficulty, for example, Japanese Patent Laid-Open No. 2005-303694 discloses a configuration in which a short-focal-length lens unit and a long-focal-length lens unit whose field angles are different from each other are provided to perform image capturing such that a same portion of an object is included in captured images. That is, inserting a zoom-up image provided by an image sensor corresponding to the long-focal-length lens into a portion of a wide-angle image provided by an image sensor corresponding to the short-focal-length lens enables providing a combined image (synthesized image) which has a high resolution in that portion and has a low resolution and a wide field angle in other portions.

However, in the multi-lens image capturing apparatus disclosed in Japanese Patent Laid-Open No. 2005-303694, each of the short-focal-length and long-focal-length lenses is separately arranged in a direction orthogonal to their optical axes. This arrangement results in parallax between the wide-angle image provided by the short-focal-length lens and the zoom-up image provided by the long-focal-length lens, causing a positional shift of the object (object positional shift) in the combined image.

Japanese Patent Laid-Open No. 2012-44459 discloses a multi-lens image capturing apparatus capable of reducing such an object positional shift generated when combining images provided by image capturing from multiple viewpoints. This multi-lens image capturing apparatus includes at least one first lens and multiple second lenses whose optical characteristics, such as an F-number, are different from that of the first lens are arranged concentrically around an optical axis of the first lens (or around a centroid of optical axes of the multiple first lenses). With this configuration, the multi-lens image capturing apparatus combines multiple captured images provided by image capturing through the multiple second lenses with shifting the captured images from each other such that same object areas included in the captured images overlap each other. Then, the apparatus combines an object area of a captured image provided by image capturing through the first lens with the overlapped object area of the combined image.

Japanese Patent Laid-Open No. 2008-217243 discloses an image producing apparatus capable of producing, when switching displayed images provided by image capturing from multiple viewpoints, an intermediate-viewpoint image which gives a user a feeling of smooth switching and does not give the used a feeling of strangeness. This image producing apparatus acquires positions, on a floor, of a same object in the multiple images provided by image capturing from the multiple viewpoints to decide an intermediate point of the positions, and then produces the intermediate-viewpoint image in which the object exists at the intermediate point.

The lens arrangement and the image combining method employed by the multi-lens image capturing apparatus disclosed in Japanese Patent Laid-Open No. 2012-44459 can provide a satisfactory image quality of the object area of a flat object while reducing the object positional shift. However, since a three-dimensional object is captured from the viewpoints of the first and second lenses as if the object were geometrically deformed, simple combination of the captured images provided by image capturing through the first and second lenses cannot be performed. Moreover, Japanese Patent Laid-Open No. 2012-44459 describes in detail the lens arrangement and the image combining method applied when the first and second lenses have field angles equal to each other, but does not clearly describe those applied when the first and second lenses have field angles different from each other. Such field angles of the first and second lenses different from each other make it impossible to combine the captured images by using the simple method described in Japanese Patent Laid-Open No. 2012-44459.

Furthermore, the image producing apparatus disclosed in Japanese Patent Laid-Open No. 2008-217243 requires, as a precondition, presence of the floor as a reference of the position of the object. However, a common image-capturing environment often lacks such a floor, which makes it impossible for the image producing apparatus to produce the intermediate-viewpoint image.

In addition, a configuration has been proposed which uses multiple optical systems (multi-lens optical system) to acquire “object side marginal space information” that has been difficult to be acquired by conventional common image-capturing systems. The object side marginal space information is a collective term for various information to express an object space, such as object distance information, object position information, object configuration information, light source information, object spectral characteristic information and object scattering characteristic information. For instance, Japanese Patent Laid-Open No. 2009-117976 discloses a configuration including paired short-focal-length lenses and paired long-focal-length lenses to thereby provide not only wide-field angle images and narrow-field angle images but also parallax images thereof. That is, this configuration can calculate distance information of the object by using a principle of triangulation while acquiring the images whose field angles are different from each other. The acquired distance information of the object is very effective for, for example, performing three-dimensional modeling of the object.

However, since the conventional configurations disclosed in Japanese Patent Laid-Open Nos. 2005-303694 and 2009-117976 include only the optical systems having two different field angles, the configurations can only acquire a specific wide-field angle image and a specific narrow-field angle image. Although conventional image-capturing apparatuses such as video cameras and digital cameras require to have a continuous zoom function in order to provide captured images having field angles desired by the user, the configurations disclosed in Japanese Patent Laid-Open Nos. 2005-303694 and 2009-117976 have a problem that a freedom degree of image-capturing field angles selectable by users is too small.

Furthermore, as for acquisition of the object distance information which is one of the object side marginal space information, it is important for the multi-lens image capturing apparatus, as described later, to have a long base length in order to improve accuracy of the object distance information. However, Japanese Patent Laid-Open No. 2009-117976 does not include any description on improving the accuracy of the object distance information with respect to the base length. Moreover, Japanese Patent Laid-Open No. 2009-117976 also does not include any description on increasing a magnification of the continuous zoom function while improving the accuracy of the object distance information in the object space in which image capturing can be performed.

### SUMMARY OF THE INVENTION

The present invention provides a multi-lens image capturing apparatus which is capable of, when performing image capturing of a three-dimensional object from mutually different viewpoints through multiple imaging optical systems whose field angles are different from one another, easily reducing the object positional shift caused by switching of the field angle. The present invention also provides a multi-lens image capturing apparatus which is advantageous for acquiring the object side marginal space information on the object space where image capturing is performed while having a reduced thickness and a high magnification ratio.

The present invention provides as one aspect thereof a multi-lens image capturing apparatus including multiple imaging optical systems arranged such that their optical axes are separate from one another in a direction orthogonal to the optical axes, and an image capturing unit in which multiple image-capturing areas each performing image capturing of an object through a corresponding one of the imaging optical systems are provided. The multiple imaging optical systems include multiple first imaging optical systems each having a first field angle and at least one second imaging optical system having a second field angle wider than the first field angle, and when viewed from a direction of the optical axes, the optical axis of the at least one second imaging optical system is located in a first area surrounded by lines connecting positions of the optical axes of the multiple first imaging optical systems.

The present invention provides as another aspect thereof a multi-lens image capturing apparatus including multiple optical systems including a first optical system and a second optical system each having a first field angle widest among those of the multiple optical systems and a third optical system having a second field angle narrower than the first field angle, and an image sensor having a first image-capturing area corresponding to the first optical system, a second image-capturing area corresponding to the second optical system and a third image-capturing area corresponding to the third optical system. The multiple optical systems are arranged such that the first and second optical systems have a longest base length therebetween among those between the multiple optical systems, and the apparatus further comprises a calculator configured to calculate object distance information on a distance to an object contained in a first captured image provided from the first image-capturing area and in a second captured image provided from the second image-capturing area, by using the first and second captured images.

Other aspects of the present invention will become apparent from the following description and the attached drawings.

### BRIEF DESCRIPTION OF THE DRAWINGS

FIG. 1 illustrates an imaging optical unit of a multi-lens image capturing apparatus that is Embodiment 1 of the present invention, which is viewed from its optical axis direction.

FIG. 2 is block diagram illustrating a configuration of the multi-lens image capturing apparatus of Embodiment 1.

FIG. 3 illustrates captured images provided by image capturing performed by the multi-lens image capturing apparatus of Embodiment 1.

FIG. 4 is a flowchart illustrating an image combining process performed in the multi-lens image capturing apparatus of Embodiment 1.

FIGS. 5A and 5B illustrate captured images to be used for a wide field angle side image combining performed in the multi-lens image capturing apparatus of Embodiment 1.

FIG. 6 explains a corresponding area extracting method used in the multi-lens image capturing apparatus of Embodiment 1 and in a multi-lens image capturing apparatus of Embodiment 5.

FIGS. 7A to 7D illustrate captured images to be used for telephoto side image combining performed in the multi-lens image capturing apparatus of Embodiment 1.

FIG. 8 is a flowchart illustrating an intermediate field angle image producing process performed with the multi-lens image capturing apparatus of Embodiment 1.

FIG. 9 is a flowchart illustrating a distance information calculating process performed in the multi-lens image capturing apparatus of Embodiment 1.

FIG. 10 illustrates an imaging optical unit of a multi-lens image capturing apparatus that is Embodiment 2 of the present invention, which is viewed from its optical axis direction.

FIG. 11 illustrates an imaging optical unit of a multi-lens image capturing apparatus that is Embodiment 3 of the present invention, which is viewed from its optical axis direction.

FIG. 12 illustrates an imaging optical unit of a multi-lens image capturing apparatus that is Embodiment 4 of the present invention, which is viewed from its optical axis direction.

FIG. 13 explains image capturing from mutually different viewpoints.

FIGS. 14A to 14C explain an object positional shift in captured images.

FIG. 15 illustrates a configuration of a multi-lens image capturing apparatus that is Embodiment 5 of the present invention.

FIG. 16 explains captured images in Embodiment 5.

FIG. 17 is a flowchart of a continuous zoom function in Embodiment 5.

FIG. 18 is a flowchart of a distance information calculation in Embodiment 5.

FIG. 19 illustrates a configuration of a multi-lens image capturing apparatus that is Embodiment 6 of the present invention.

FIG. 20 is a configuration diagram of a multi-lens image capturing apparatus in Embodiment 7.

FIG. 21 explains a best shot mode performed by the multi-lens image capturing apparatus.

FIG. 22 explains the captured images for the continuous zoom function.

FIG. 23 explains a three-dimensional image capturing model.

### DESCRIPTION OF THE EMBODIMENTS

Exemplary embodiments of the present invention will be described below with reference to the attached drawings.

Multi-lens image capturing apparatuses of first to fourth embodiments (Embodiments 1 to 4) of the present invention each include multiple fixed-focal-length imaging optical systems whose field angles (focal lengths) are mutually different so as to make it unnecessary to have a zoom mechanism which moves a magnification-varying optical element along an optical axis, thereby reducing a thickness of the apparatus while ensuring a high zoom ratio. The multi-lens image capturing apparatus of each embodiment is capable of producing images whose field angles are continuously changed, by using images provided by image capturing through the multiple imaging optical systems whose field angles are discretely different from one another. The image provided by image capturing through the imaging optical system is hereinafter simply referred to as “a captured image through the imaging optical systems.”

A digital zoom function which trims a partial area of a captured image provided through the imaging optical system having a certain field angle and enlarges the trimmed image area to a predetermined size to make it possible to provide a virtual zooming effect is equipped with general image-capturing apparatuses. The multi-lens image capturing apparatus of each embodiment interpolates the discrete field angles of the multiple imaging optical systems by a digital zoom process to enable continuous zooming. In this embodiment, this digital zoom process is also referred to as “an intermediate-field-angle-image producing process”.

In addition, the multi-lens image capturing apparatus of each embodiment combines (synthesizes) a telephoto captured image provided through the imaging optical system corresponding to a telephoto lens with part of another image provided by the digital zoom. This image combining enables producing a combined image having a high resolution in the telephoto image part and having a low resolution and a wide field angle in other parts. In this embodiment, this image combining is referred to as “a different-field-angle-images combining process”.

In the intermediate-field-angle-image producing process and the different-field-angle-images combining process, captured images to be used for acquiring an intended image having a desired field angle are provided through the imaging optical systems having field angles close to the desired field angle. This enables producing a high quality image while providing a higher zoom ratio compared to a case of acquiring an intended image whose field angle is changed only by the digital zooming from that of a captured image provided through a single imaging optical system whose field angle is fixed.

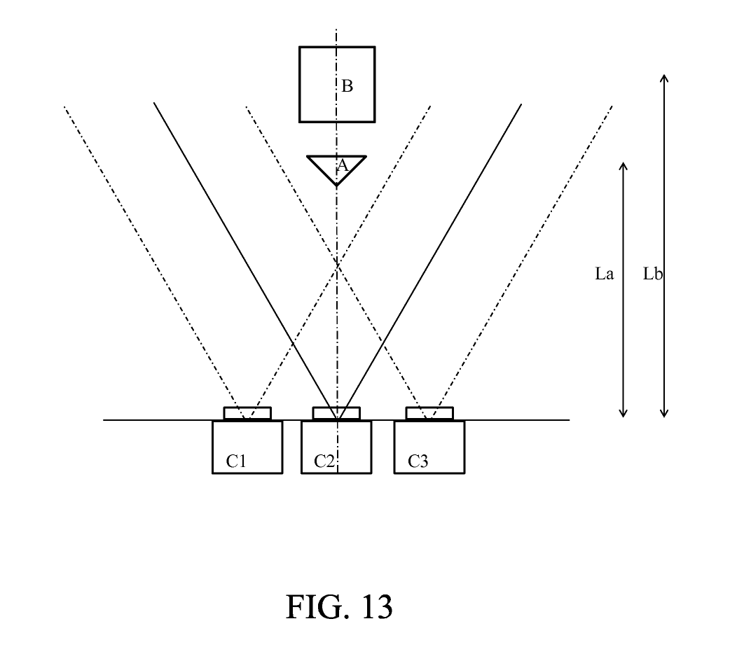

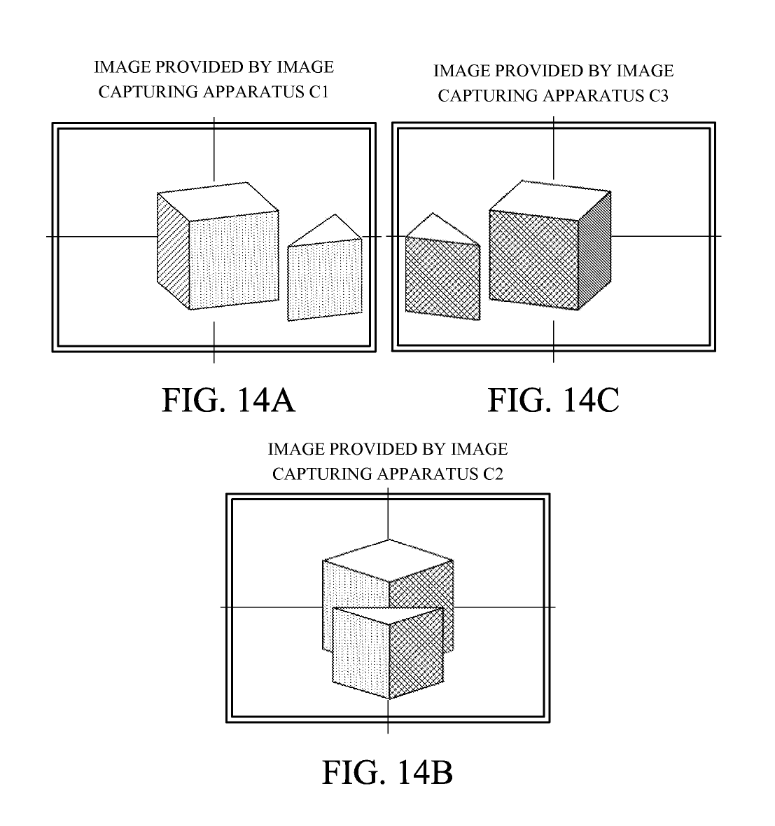

However, the multiple imaging optical systems provided to the multi-lens image capturing apparatus of each embodiment are arranged such that their optical axes are separate from one another in directions orthogonal to the optical axes and are each provided with an image-capturing area (photoelectric-conversion area) to perform image capturing of an object through that imaging optical system. For this reason, captured images provided through the imaging optical systems whose field angles are mutually different have parallax. This parallax causes positions of the object (object image) in the respective captured images to largely move due to changing of the field angle. A reason and a principle thereof will be described with reference to FIGS. 13 and 14A to 14C.

FIG. 13 illustrates a situation in which image capturing apparatuses C1, C2 and C3 arranged separately from one another with a certain distance (base length) capture an object A located away from each image-capturing apparatus by an object distance La and an object B located away therefrom by an object distance Lb. FIGS. 14A to 14C illustrate captured images provided by image capturing by the image-capturing apparatuses C1, C2 and C3. As can be understood from these drawings, because of a geometric relation depending on the base length and the object distances, the positions of the objects A and B in the captured images are shifted by different amounts from each other. That is, the positions of the objects A and B in the captured images are moved depending on viewpoints.

For this reason, the multi-lens image capturing apparatus of each embodiment has the following configuration so as to enable changing its field angle by using imaging optical systems which have mutually different field angles and which provide mutually different viewpoints, while reducing an object positional shift in the captured image. That is, in each embodiment, as the multiple imaging optical systems, multiple first imaging optical systems each having a first field angle and at least one second imaging optical system having a second field angle wider than the first field angle are provided. When viewed from a direction of the optical axes of the imaging optical systems (the direction is hereinafter referred to as “an optical axis direction”), the optical axis of the second imaging optical system is located in a first area surrounded by lines connecting positions of the optical axes of the multiple first imaging optical systems. This configuration enables changing, with respect to a captured image as a base image provided through the second imaging optical system, viewpoint positions of captured images provided through the multiple first imaging optical systems with good accuracy. This makes it possible to easily reduce the object positional shift caused by changing of the field angle.

Moreover, in each embodiment, it is desirable that, among the mutually different field angles (including not only the first and second field angles, but also third and fourth field angles intermediate therebetween) of the multiple imaging optical systems, a field angle W and a next narrower field angle Wn than the field angle W satisfy following expression (1):

1.1≦W/Wn≦3 (1)

A lower value of W/Wn than the lower limit of expression (1) makes it necessary for the multi-lens image capturing apparatus to have a significantly large number of the imaging optical systems to achieve a high zoom ratio, which undesirably increases a size of the apparatus. A higher value of W/Wn than the upper limit of expression (1) makes it difficult to maintain a high resolution even in a case of producing a pixel-shifted combined image described later, which undesirably degrades quality of the combined image after zooming up.

Specific configuration examples of this embodiment will be described below as Embodiments 1 to 4.

### Embodiment 1

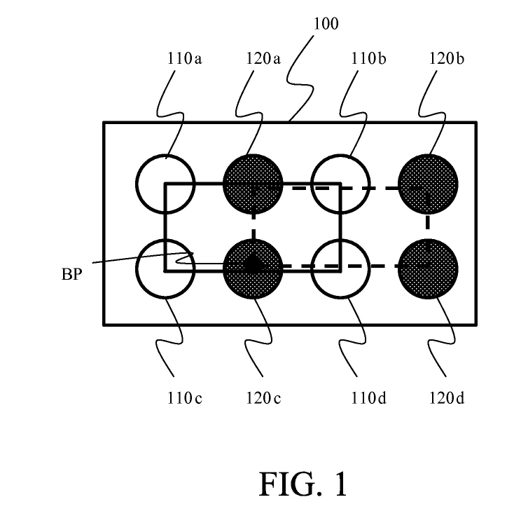

FIG. 1 is an optical-axis-direction view illustrating an imaging optical unit 100 of a multi-lens image capturing apparatus 1 that is Embodiment 1 of the present invention, which is viewed from its optical axis direction. The imaging optical unit 100 includes multiple imaging optical systems 110a, 110b, 110c, 110d, 120a, 120b, 120c and 120d. The multiple imaging optical systems 110a to 110d and 120a to 120d are arranged such that their optical axes are separate from one another in a two-dimensional direction orthogonal to the optical axes. The optical axes of the imaging optical systems 110a to 110d and 120a to 120d extend parallel to one another.

The imaging optical systems 110a to 110d are multiple first imaging optical systems each having a first field angle (focal length) e, all of which are hereinafter collectively referred to also as “a first imaging optical system group”. The first field angle θ corresponds to a telephoto-end field angle which is a narrowest field angle in the multi-lens image capturing apparatus of this embodiment. On the other hand, the imaging optical systems 120a to 120d are second imaging optical systems each having a second field angle wider than the first field angle θ (in this embodiment, 2θ which is twice as wide as the first field angle θ), all of which are hereinafter collectively referred to also as “a second imaging optical system group”. The second field angle 2θ corresponds to a wide-angle-end field angle which is a widest field angle in the multi-lens image capturing apparatus of this embodiment. In this embodiment, the two first imaging optical systems arranged in a vertical direction and the two second imaging optical systems arranged in the vertical direction are alternately arranged in a horizontal direction (from left to right in FIG. 1).

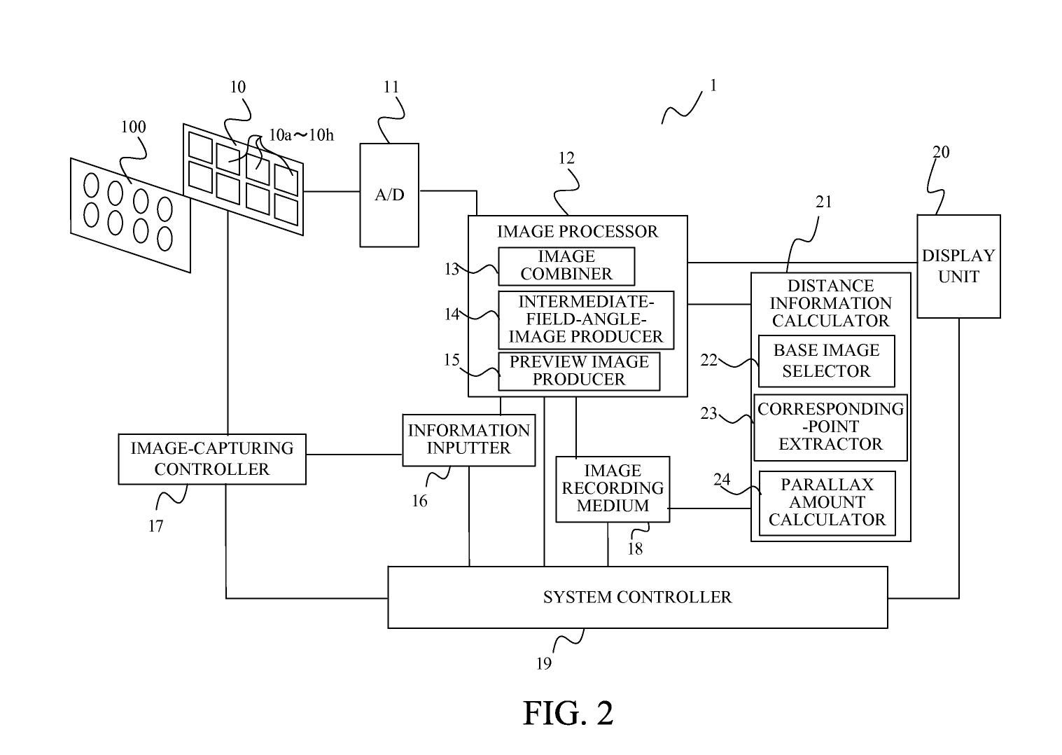

FIG. 2 illustrates an entire configuration of the multi-lens image capturing apparatus 1 of this embodiment. The multi-lens image capturing apparatus 1 includes the above-described imaging optical unit 100, an image sensor unit (image capturing unit) 10, an A/D converter 11, an image processor 12, an information inputter 16, an image-capturing controller 17, an image recording medium 18, a system controller 19 and a display unit 20. The multi-lens image capturing apparatus 1 further includes a distance information calculator (distance calculator) 21.

The multi-lens image capturing apparatus 1 may be an imaging-optical-system-integrated image capturing apparatus with which the imaging optical unit 100 is integrally provided or may be an imaging-optical-system-interchangeable image capturing apparatus to which the imaging optical unit 100 is detachably (interchangeably) attached. This embodiment will describe a case where the multi-lens image capturing apparatus 1 is the imaging-optical-system-integrated image capturing apparatus.

The image sensor unit 10 includes eight image sensors 10a to 10h constituting image-capturing areas respectively corresponding to (that is, provided for) the above-described eight imaging optical systems 110a to 110d and 120a to 120d. Each of the image sensors 10a to 10h photoelectrically converts an object image (optical image) formed by the imaging optical system corresponding thereto to output an analog image-capturing signal. The analog image-capturing signal is converted by the A/D converter 11 into a digital image-capturing signal, and the digital image-capturing signal is input to the image processor 12. The image processor 12 performs, on the digital image-capturing signal, various image processes such as a pixel interpolation process and a color conversion process to produce an image (captured image). Image capturing through the eight imaging optical systems 110a to 110d and 120a to 120d is thus performed, and thereby eight captured images are produced. The image processor 12 also performs a digital zoom process and the like on each captured image. Each captured image processed by the image processor 12 is sent to the system controller 19.

The image processor 12 includes an image combiner (or image synthesizer) 13, an intermediate-field-angle-image producer 14 and a preview-image producer 15.

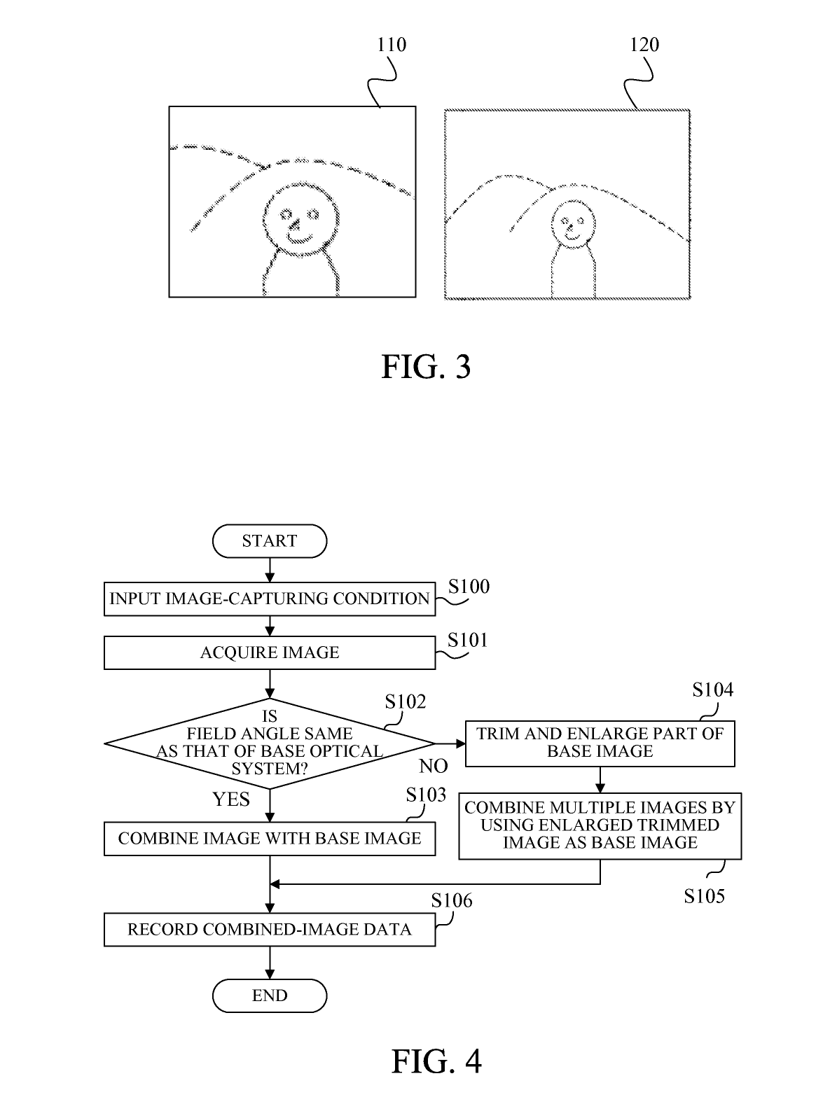

The image combiner 13 combines the four images provided by image capturing through (hereinafter simply referred to “provided through”) the first imaging optical systems 110a to 110d such that pixels of the four images are shifted from one another, to produce a first combined image 110 as a pixel-shifted combined image illustrated in FIG. 3. Moreover, the image combiner 13 combines the four images provided through the second imaging optical systems 120a to 120d such that pixels of the four images are shifted from one another, to produce a second combined image 120 as another pixel-shifted combined image whose field angle is wider than that of the first combined image 110 illustrated in FIG. 3.

In FIG. 1, positions of the optical axes of the first imaging optical systems 110a to 110d are connected by solid lines (straight lines) extending in the vertical and horizontal directions. An area surrounded by the solid lines is defined as the above-mentioned first area. Moreover, positions of the optical axes of the second imaging optical systems 120a to 120d are connected by dashed lines (straight lines) extending in the vertical and horizontal directions. An area surrounded by the dashed line is defined as a second area. In FIG. 1, for ease of reference to the solid line and the dashed line, the dashed line is drawn to be slightly displaced from the positions of the optical axes of the second imaging optical systems 120a to 120d.

As understood from FIG. 1, in this embodiment, the optical axis of the single second imaging optical system 120c among the multiple second imaging optical systems 120a to 120d is located in the first area. Hereinafter, a viewpoint from the second imaging optical system 120c is referred to as “a base viewpoint BP”, and the second imaging optical system 120c is referred to also as “a base optical system”. This positional relation enables using the captured image provided through the base optical system 120c, whose viewpoint is the base viewpoint BP, as a base (base image) when combining the four images provided through the first imaging optical systems 110a to 110d to produce the first combined image.

The image combiner 13 combines, by using a corresponding point search method using the base image such as a block matching method described later, the captured images provided through the imaging optical systems having the same field angle or through the imaging optical systems having the field angles different from one another. This image combining enables producing a combined image corresponding to each of all image-capturing field angles as an image virtually provided by the image capturing from the base viewpoint BP. Producing such a combined image consequently makes it possible to reduce the object positional shift between the combined images 110 and 120 generated when change of the image-capturing field angle (zooming) is performed from an image-capturing state for the second combined image 120 provided through the second imaging optical system group to an image-capturing state for the first combined image 110 provided through the first imaging optical system group.

The intermediate-field-angle-image producer produces an intermediate-field-angle image to be used to interpolate a field angle (intermediate field angle) intermediate between the mutually different field angles that the first and second imaging optical system groups discretely have. As a method of producing the intermediate-field-angle image, a super-resolution process can be employed which performs a resolution-increasing process by using multiple images. As the super-resolution process, an ML (Maximum-Likelihood) method, an MAP (Maximum A Posterior) method, a POCS (Projection Onto Convex Set) method, an IBP (Iterative Back Projection) method, an LR (Lucy-Richardson) method or the like can be used. Furthermore, as mentioned above, in this embodiment, the intermediate-field-angle-image producer 14 combines (inserts) with the telephoto captured image provided through the first imaging optical system group corresponding to the telephoto lens with (into) a partial area of the image provided by the digital zoom. With this image combining, the intermediate-field-angle-image producer 14 performs the different-field-angle-images combining process which enables providing an image having an intermediate field angle that has a high resolution in the partial area and has a low resolution in other areas.

The preview-image producer 15 produces a preview image from the base image provided through the base optical system 120c. In response to a user's instruction to change the field angle, the preview-image producer 15 trims the captured image provided through the base optical system 120c which is the base viewpoint BP, enlarges the trimmed image and displays the enlarged image on the display unit 20, thereby enabling displaying a preview image consistently seen from the same viewpoint.

The information inputter 16 detects information on desired image-capturing condition, such as an aperture value and an exposure time, selected and input by a user to supply data thereof to the system controller 19. The image-capturing controller 17 received the information from the system controller 19 moves a focus lens (not illustrated) included in each imaging optical system in the optical axis direction, controls the aperture value of each imaging optical system and the exposure time for the image sensor unit 10 to enable providing a required captured image.

The image recording medium 18 stores multiple still images and motion images, and stores a file header when forming an image file.

The display unit 20 displays the preview image as described above and displays the captured image provided by image capturing, a menu, information on a currently selected field angle (focal length) and the like. The display unit 20 includes a display element such as a liquid crystal panel.

The distance information calculator 21 includes a base image selector 22, a corresponding-point extractor 23 and a parallax amount calculator 24.

The base image selector 22 selects the base image to be used for object distance calculation, from the multiple captured images (parallax images) having parallax to one another provided through the multiple imaging optical systems.

The corresponding-point extractor 23 extracts corresponding pixels (corresponding points) between the base image to be used for the object distance calculation and another parallax image (reference image).

The parallax amount calculator 24 calculates a parallax amount of each of all the corresponding pixels extracted by the corresponding-point extractor 23. The distance information calculator 21 calculates, from the calculated parallax amount, a distance (object distance information) to an object included in the base image.

Next, with reference to a flowchart of FIG. 4, description will be made of an image combining process for switching of the image-capturing field angle performed mainly by the system controller 19 and the image combiner 13 according to a first image processing program as a computer program.

First, at step S100, the system controller 19 transfers, in response to a user's input of information on the image-capturing condition and a signal (image-capturing preparation signal) instructing a preparation for image capturing through the information inputter 16, the image-capturing condition information and the image-capturing preparation signal to the image-capturing controller 17. The image-capturing controller 17 sets the aperture values of the first and second imaging optical system groups, the exposure time (shutter speed) for the image sensor unit 10 and the like on a basis of the input image-capturing condition information. At this step, the user inputs either one of the field angles of the first and second imaging optical system groups.

Next, at step S101, the system controller 19 causes, in response to a user's input of a signal (image-capturing start signal) instructing start of image capturing through the information inputter 16, the image-capturing controller 17 to start exposure of the image sensor unit 10 (image sensors 10a to 10h). Analog image-capturing signals output from the image sensors 10a to 10h are converted by the A/D converter into digital image-capturing signals and then sent to the image processor 12. The image processor 12 produces captured images corresponding to object images formed on the image sensors 10a to 10h from the digital image-capturing signals. In this image producing, it is desirable that the image processor 12 perform a process to match luminance levels and white balances of the captured images to one another. This process enables reducing adverse factors such as luminance unevenness and color unevenness in the image combining process subsequently performed.

Next, at step S102, the system controller 19 determines whether or not the field angle input by the user at step 100 is same as the field angle (base field angle) of the second imaging optical system group including the base optical system 120c. It is desirable that the base field angle be widest among those of the multiple imaging optical system groups included in the multi-lens image capturing apparatus 1. As understood from FIG. 3, the narrow-field angle image (first combined image) 110 includes no information on a peripheral area of the wide-field angle image (second combined image) 120. For this reason, it is difficult to match positions of the multiple captured images provided by the wide-field angle imaging optical system group to one another, by using as a base the captured image provided by the narrow-field angle imaging optical system group. The system controller 19 proceeds to step S103 if the field angle input by the user is same as the base field angle and proceeds to step S104 if not.

At step S103, the image combiner 13 performs a base-field-angle-images combining process to combine the captured images provided through the second imaging optical systems 120a, 120b and 120d with the base image provided through the base optical system 120c.

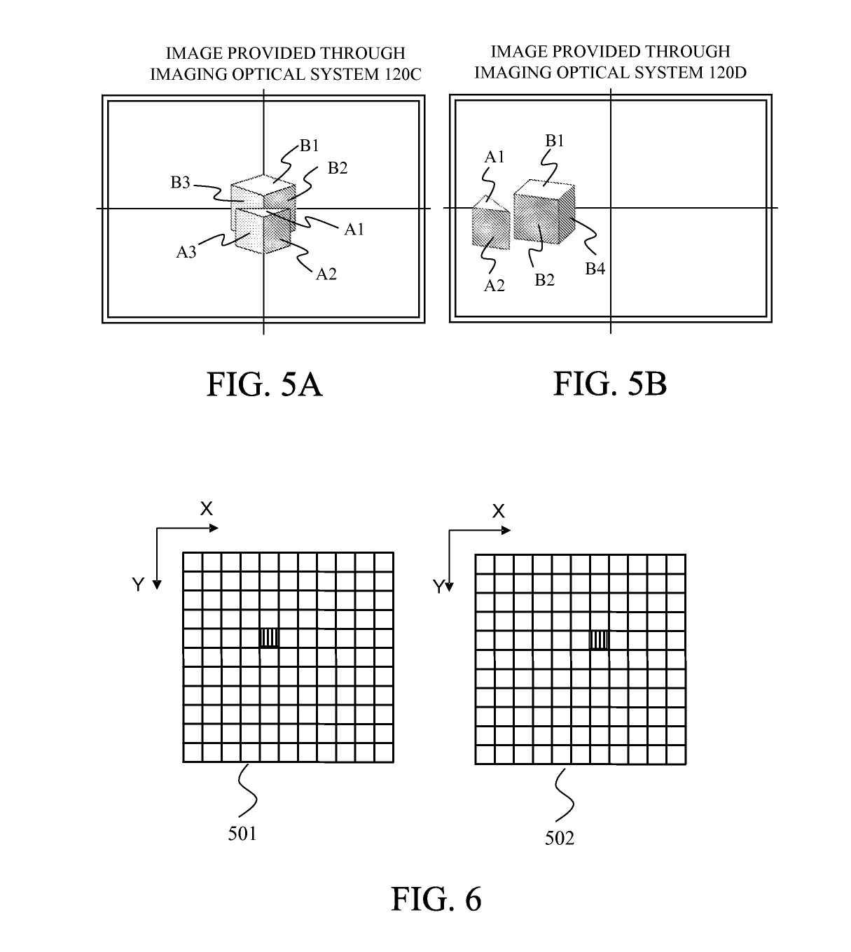

Description will now be made of a method of combining the captured images provided through the second imaging optical systems 120a, 120b and 120d each having the same field angle as that (base field angle) of the base optical system 120c. FIGS. 5A and 5B illustrate captured images provided through the second imaging optical systems 120c and 120d when the objects A and B, which are illustrated also in FIG. 13, are captured by the multi-lens image capturing apparatus 1. In the captured images provided through the second imaging optical system 120c and 120d, because of a geometric relation depending on the base length which is a distance between the optical axes of the second imaging optical systems 120c and 120d and on the object distances which are distances to the objects A and B, positions of the objects A and B are shifted by mutually different amounts. In addition, because of a difference in viewpoint between the parallax images, each of the objects A and B in those images has a portion captured and a portion not captured. For instance, in the captured image (FIG. 5A) provided through the second imaging optical system 120c, a surface A3 of the object A and a surface B3 of the object B are captured. However, in the captured image (FIG. 5B) provided through the second imaging optical system 120d, the faces A3 and B3 are not captured. Conversely, in the image (FIG. 5B) provided through the second imaging optical system 120d, a face B4 of the object B is not captured which is captured in the image (FIG. 5A) provided through the second imaging optical system 120c. Such a state in which an object area included in one of two captured images is not included in the other of the two images due to the difference in viewpoint is called “occlusion”.

The image combining process in this embodiment uses the captured image (FIG. 5A) provided through the base optical system 120c as the base image and extracts, from the captured image (FIG. 5B) provided through the second imaging optical system different from the base optical system 120c, an object area (corresponding point) corresponding to an object area included in the base image to combine the extracted object area with the object area in the base image.

A method of extracting the corresponding point (paired corresponding points between the base and reference images) will be described with reference to FIG. 6. In FIG. 6, a base image 501 which corresponds to the captured image illustrated in FIG. 5A is illustrated at a left side part, and a reference image 502 which corresponds to the captured image illustrated in FIG. 5B and is combined with the base image 501 is illustrated at a right side part. In this drawing, image coordinates (X,Y) are used which indicate positions in horizontal (X) and vertical (Y) directions in the base image 501 and the reference image 502. An upper left pixel of each of the images 501 and 502 illustrated in FIG. 6 is defined as an origin of the image coordinates (X,Y). In addition, F1(X,Y) represents a luminance at the image coordinates (X,Y) in the base image 501, and F2(X,Y) represents a luminance at the image coordinates (X,Y) in the reference image 502.

A pixel (hatched in the drawing) in the reference image 502 corresponding to a pixel (hatched in the drawing) in the base image 501 located at arbitrary coordinates (X,Y) can be determined by searching for a pixel in the reference image 502 having a luminance most similar to the luminance F1(X,Y) in the base image 501. However, since it is not easy to search for the pixel having the most similar luminance to the luminance of the arbitrary pixel, the above-mentioned block matching method using also pixels located near the image coordinates (X,Y) is employed to search for a pixel having a similar luminance to that in the base image.

As an example, description will be made of a process of the block matching method performed when a block size is 3 Three pixels). Luminance values of a total of the three pixels which are one pixel in the base image 501 located at arbitrary coordinates (X,Y) and two pixels located at right- and left-adjacent coordinates (X−1,Y) and (X+1,Y) to the arbitrary coordinates (X,Y) are:

### F1(X,Y), F1(X−1,Y) and F1(X+1,Y).

On the other hand, luminance values of pixels in the reference image 502 shifted from the coordinates (X,Y), (X−1,Y) and (X+1,Y) by a distance k in the X direction are: F2(X+k,Y),F2(X+k−1,Y) and F2(X+k+1,Y).

With this definition, a degree of similarity E to the pixel in the base image 501 located at the coordinate (X,Y) is defined by following expression (2):

$$E = [ F 1 ( X , Y ) - F 2 ( X + k , Y ) ] + [ F 1 ( X - 1 , Y ) - F 2 ( X + k - 1 , Y ) ] + [ F 1 ( X + 1 , Y ) - F 2 ( X + k + 1 , Y ) ] = {\sum }_{j = - 1}^{1} [ F 1 ( X + j , Y ) - F 2 ( X + k + j , Y ) ] \qquad ( 2 )$$

The coordinate (X+k,Y) having a lowest degree of similarity E resulted by sequential calculations of the degree of similarity E with changing the value of k in expression (2) is the pixel (one of the paired corresponding points) in the reference image 502 corresponding to the coordinate (X,Y) in the base image 501. In a similar manner to the above-described method of extracting the corresponding points between the captured images each having the parallax in the horizontal direction, it is also possible to extract the corresponding points between captured images having the parallax in the vertical direction or in an oblique direction.

Combining the object area as the corresponding point acquired as described above with the base image 501 pixel by pixel enables reducing a noise level in the base image 501 and thereby making it possible to improve quality of a combined image to be output.

The faces A3 and B3 of the objects A and B illustrated in FIG. 5A are included in occlusion areas in FIG. 5B, and therefore no object area corresponding to the faces A3 and B3 exists in FIG. 5B. Thus, the faces A3 and B3 are not combined from the captured image provided through the second imaging optical system 120d. Moreover, the face B4 of the object B captured only in FIG. 5B is not captured in the base image, so that the face B4 is not used for the image combining. As described above, the occlusion area cannot be combined, but other most object areas of the captured image provided by image capturing from a viewpoint different from the base viewpoint BP can be combined with the base image. This image combining makes it possible to reduce the noise level of the combined image as a whole.

If the base and reference images originally have a large parallax generating a significant difference in shapes of the object areas between these images and thereby the block matching method cannot be applied, the block matching method in the image combining process may be performed after a geometric conversion such as an Affine transform is performed on the reference image. In a similar manner to the above-described image combining process (image combining method), the captured images provided through the second imaging optical systems 120a and 120b also can be combined with the base image.

On the other hand, at steps S104 and S105, the system controller 19 performs the above-mentioned different-field-angle-images combining process which is an image combining process to be performed when the field angle input by the user is different from the base field angle.

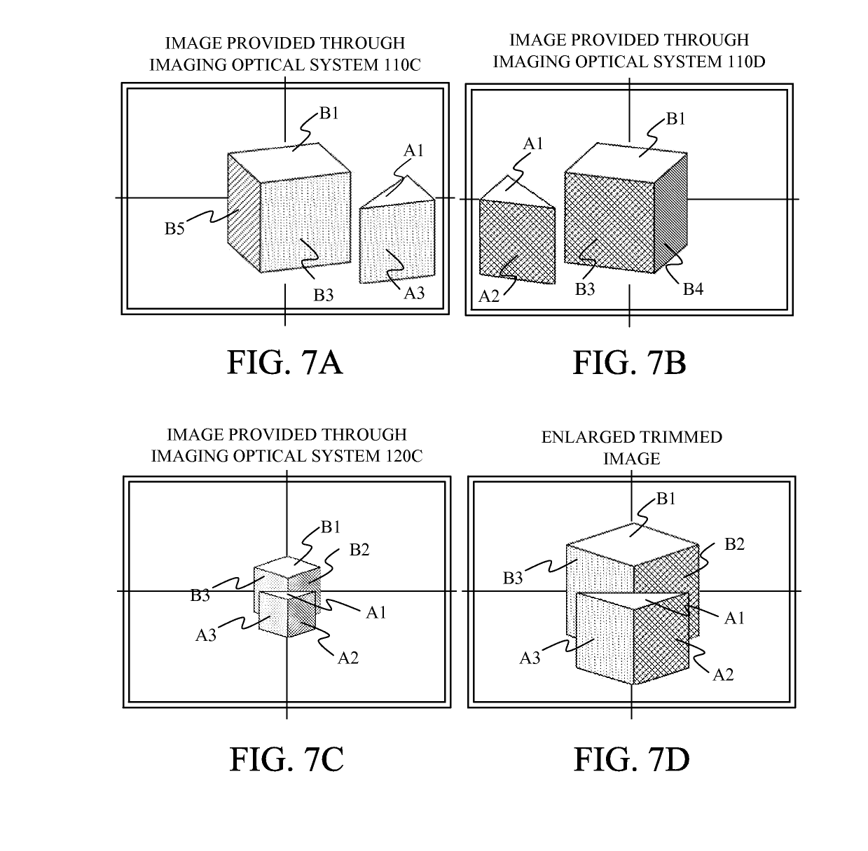

The different-field-angle-images combining process will now be described with reference to FIGS. 7A to 7D. FIGS. 7A and 7B illustrate the captured images provided through the first imaging optical systems 110C and 110d when the objects A and B, which are illustrated also in FIG. 13, are captured by the multi-lens image capturing apparatus 1. FIG. 7C illustrates the base image provided through the base optical system 120c when the objects A and B to those in FIG. 13 are captured by the multi-lens image capturing apparatus 1.

The captured images provided through the first imaging optical systems 110C and 110d are each a narrower field angle image than the base image provided through the base optical system 120c. For this reason, the objects A and B in the captured images provided through the first imaging optical systems 110C and 110d have sizes different from those in the base image, which makes it impossible to combine these images without performing any process thereon. Therefore, first, at step S104, the image combiner 13 performs a trimming process and an enlarging process on part of the base image provided through the base optical system 120c in order to match a size of the base image to a user input field angle (the field angle of the first imaging optical system group in this description). FIG. 7D illustrates an image provided by enlarging the trimmed part (central area) of the base image illustrated in FIG. 7C such that the trimmed part becomes an image whose field angle corresponds to those of the first optical systems 110C and 110d. Although the trimming and enlarging processes degrade resolution of that image, these processes enable providing a new base image (hereinafter referred to as “an enlarged base image”) in which an object is included whose size is equivalent to that of the object in the captured images provided through the first imaging optical systems 110C and 110d.

Then, at step S105, the image combiner 13 combines the captured images provided through the first imaging optical systems 110a to 110d by using the enlarged base image provided at step S104. Similar to the image combining method described at step S103, an image combining method used at this step can also combine, pixel by pixel, the object area included in the captured images provided through the first imaging optical systems 110a to 110d with the enlarged base image illustrated in FIG. 7D. On the other hand, as described above, the resolution of the enlarged base image illustrated in FIG. 7D is degraded by the enlarging process. Therefore, an image combining method may be used which decides object areas corresponding to each other in the captured images provided through the first imaging optical systems 110a to 110d by using the enlarged base image and combines the captured images other than the enlarged base image with one another (that is, the enlarged base image is not combined) with matching positions of the decided object areas to one another.

In this embodiment, the base optical system 120c is disposed in the first area illustrated in FIG. in which the optical axes of the first imaging optical system group (first imaging optical systems) are included. Moreover, the first imaging optical systems are two-dimensionally arranged such that their optical axes are parallel to one another. As illustrated in FIGS. 7A to 7D, this arrangement causes all the object areas included in the base image provided through the base optical system 120c disposed at the base viewpoint BP to be included in at least one of the multiple captured images provided through the first imaging optical system group. That is, the occlusion does not occur in the object areas in the base image.

For instance, among the faces A1 to A3 and B1 to B3 included in the enlarged base image illustrated in FIG. 7D, the faces A1, A3, B1 and B3 are included in the image illustrated in FIG. 7A and the faces A2 and B2 are included in the image illustrated in FIG. 7B. Therefore, all the object areas included in the enlarged base image are provided from at least one of the captured images illustrated in FIGS. 7A and 7B. In addition, the object position information from the base viewpoint BP can be clearly determined on a basis of the enlarged base image, which is the trimmed and enlarged image. Therefore, accuracy in the position matching by the block matching method can be improved. Furthermore, using the base image eliminates a necessity of performing a viewpoint interpolation process and the like using the object distance information, which enables significantly reducing a calculation processing load. Moreover, as described above, combining the images whose field angles are different from one another is performed with consistently using, as the base, the base image provided through the base optical system 120c disposed at the base viewpoint BP, which makes it possible to reduce the object positional shift generated when the image-capturing field angle is switched.

After proceeding from steps S103 and S105 to step S106, the system controller 19 stores the combined image to the recording medium 18 and then ends the image combining process.

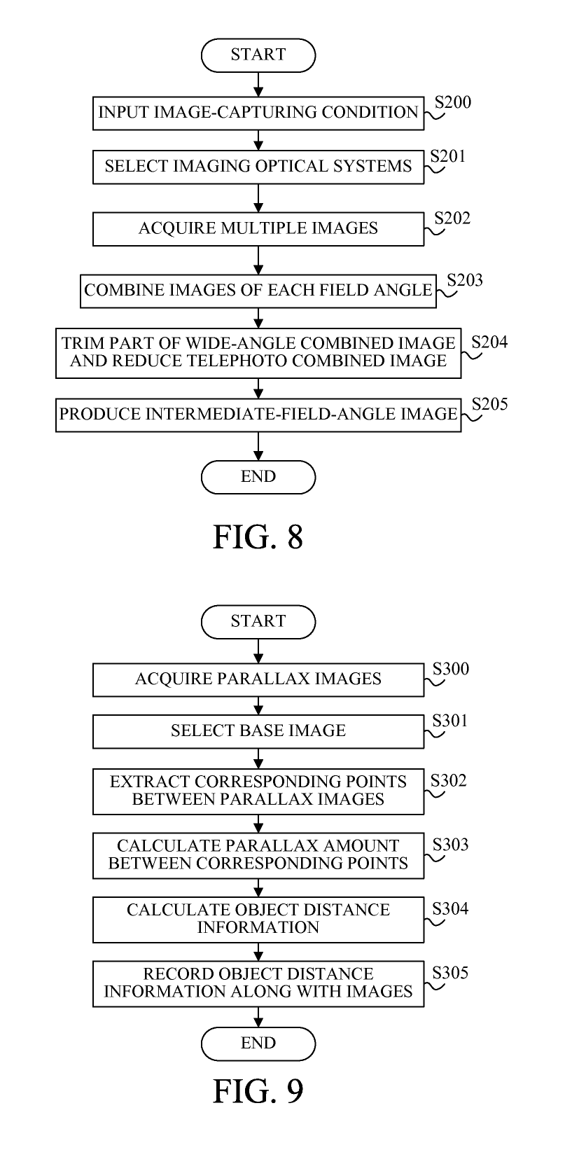

Next, the intermediate-field-angle-image producing process for realizing the above-mentioned continuous zooming performed mainly by the system controller 19, the image combiner 13 and the intermediate-field-angle-image producer 14 will be described with reference to a flowchart of FIG. 8. The intermediate-field-angle-image producing process is performed according to a second image processing program as a computer program.

First, at step S200, in response to the input of the information of the image-capturing condition and on the field angle which are specified by the user through the information inputter 16, the system controller 19 transfers the information on the image-capturing condition and on the field angle to the image-capturing controller 17. In this embodiment, description will be continued of a case where the intermediate field angle between the field angle of the first imaging optical system group and the field angle of the second imaging optical system group is input by the user at this step.

Next, at step S201, the image-capturing controller 17 selects the imaging optical systems to be used for image capturing depending on the field angle input by the user. Since the intermediate field angle is input at step S200, the image-capturing controller 17 selects, as the imaging optical systems to be used for image capturing, all the imaging optical systems including the first and second imaging optical system groups

Next, at step S202, the image-capturing controller 17 starts exposure of the image sensors of the image sensor unit 10 which correspond to the selected imaging optical systems. Thereafter, the image processor 12 produces captured images from digital image-capturing signals input from the image sensors via the A/D converter 11. Consequently, a captured image group provided through the first imaging optical system group and having mutually same field angles is produced, and a captured image group provided through the second imaging optical system group and having mutually same field angles provided through the second imaging optical system group.

In this image producing, it is desirable that the image processor 12 perform the process to match the luminance levels and the white balances of those images to one another. This process enables reducing the above-mentioned adverse factors such as the luminance unevenness and the color unevenness that occur in the image combining process performed in subsequent steps.

Next, at step S203, the image combiner 13 performs the base-field-angle-images combining process, which is performed at step S103 in FIG. 4, on the captured image group provided through the first imaging optical system group to produce the first combined image and performs the different-field-angle-images combining process, which is performed at steps S104 and S105 in FIG. 4, on the captured image group provided through the second imaging optical system group to produce the second combined image. At this step, the image combiner 13 produces the first and second combined images whose field angles are different from each other as same-viewpoint images corresponding to captured images provided by image capturing from the base viewpoint BP.

Next, at step S204, the intermediate-field-angle-image producer 14 trims a partial area corresponding to the user input field angle from the second combined image, which is a wide-angle combined image provided through the second imaging optical system group and enlarges the partial area.

Furthermore, the intermediate-field-angle-image producer 14 performs, depending on the user input field angle, a reducing process on the first combined image, which is a telephoto combined image provided through the first imaging optical system group, to reduce a size of the first combined image.

Next, at step S205, the intermediate-field-angle-image producer 14 combines, by the above-described mutually-different-field-angle-images combining process, the enlarged image provided by trimming and enlarging part of the second combined image and the reduced image (reduced-sized image) provided by reducing part of the first combined image to produce the intermediate-field angle image. Thereafter, the intermediate-field-angle-image producer 14 ends this process.

Such an intermediate-field angle-image producing process produces the intermediate-field-angle image corresponding to a captured image provided by image capturing from the base viewpoint BP, which enables producing the intermediate-field-angle image with a little object positional shift even when the intermediate field angle is selected in the continuous zooming.

Furthermore, the preview-image producer 15 produces a preview image from the base image provided through the base optical system 120c located at the base viewpoint BP and displays the preview image on the display unit 20. The preview-image producer 15 trims, even when the user instructs to change the field angle (that is, to perform zooming), part of the base image and enlarges the trimmed part of the base image, which makes it possible to produce and display the preview image as an image consistently seen from the same viewpoint. Consequently, all the images from the preview image to a final-field-angle image which is produced when the field angle is changed are each produced as the image provided by image capturing from the same base viewpoint BP, which allows the user to view an image that gives the user a little feeling of strangeness due to the object positional shift.

Next, an object-distance-information recording process performed mainly by the system controller 19 and the distance information calculator 21 will be described with reference to a flowchart of FIG. 9. The object-distance-information recording process is performed according to a third image processing program as a computer program. First, description will be made of the object-distance-information recording process using the parallax images provided through the second imaging optical system group (second imaging optical systems 120c and 120d) which captures a widest object space.

At step S300, the system controller 19 receives, from the information inputter 16, the image-capturing preparation signal input by the user. In response thereto, the system controller 19 transfers image-capturing signals output from the image sensors of the image sensor unit 10 which correspond to the second imaging optical systems 120c and 120d via the A/D converter 11 to the image processor 12. The image processor 12 produces, from the image-capturing signals, two parallax images (captured images) provided through the second imaging optical systems 120c and 120d.

Next, at step S301, the base image selector 22 selects one of the two produced parallax images as a base image for calculating a parallax amount (that is, for calculating an object distance). In this embodiment, the base image selector 22 selects the captured image provided through the second imaging optical system 120c as the base image.

Next, at step S302, the corresponding-point extractor 23 detects corresponding pixels (corresponding points) between the base image and the captured image as a reference image provided through the second imaging optical system 120d. The “corresponding pixels” are, for example, paired pixels, in the two parallax images provided by imaging capturing of an object A, where a same point of the object A is captured. As a method of detecting the corresponding pixels, the corresponding-point extraction method described in the aforementioned image combining process can be employed.

Next, at step S303, the parallax amount calculator 24 calculates the parallax amount between the extracted corresponding points. Specifically, the parallax amount calculator 24 calculates the parallax amount as a difference between positions of the corresponding pixels in the base and reference images.

Next, at step S304, the distance information calculator 21 calculates the object distance from the parallax amount calculated at step S303 and from the focal lengths of the second imaging optical systems 120c and 120d and the base length therebetween; the focal lengths and the base length are known. Although this step describes the calculation of the object distance when a pair of the second imaging optical systems 120c and 120d is used, the object distance can be also calculated, on a basis of a similar principle, when alternatively using a pair of other imaging optical systems (for example, a pair of the second imaging optical systems 120a and 120b). When the above-described method is used for the parallax images whose field angles are different from each other, it is desirable to clip, from a wider-field-angle one of the parallax images, a portion corresponding to the other (narrower-field-angle) parallax image and to extract one of the corresponding pixels from the clipped portion.

As described above, this embodiment can reduce a thickness of the multi-lens image capturing apparatus and reduce the object positional shift in the image caused by zooming while ensuring a high zoom ratio.

In addition, this embodiment can realize various image-capturing modes. For instance, in a high dynamic range mode, the apparatus performs image capturing multiple times while sequentially changing imaging optical systems constituting multi-lens optical systems and an exposure condition of the image sensors corresponding to the multi-lens optical systems and then combines multiple images provided by the multiple-time image capturing, thereby making it possible to provide a wide-dynamic-range image. In a blur-added mode, the apparatus adds blur to a background of the image on a basis of calculated object distance information, thereby making it possible to provide an image in which a main object is enhanced. Moreover, in a background-removing mode, the apparatus can provide an image whose background other than a main object is removed on a basis of the object distance calculated as described above. Furthermore, in a three-dimensional image capturing mode, the apparatus acquires left and right parallax images by using the imaging optical systems horizontally arranged and constituting the multi-lens optical systems and their corresponding image sensors. The apparatus then stores, as parallax images providing a three-dimensional image, a narrower-field-angle one of the acquired parallax images and part of the other (wider-field-angle parallax image) corresponding the narrower-field-angle parallax image.

### Embodiment 2

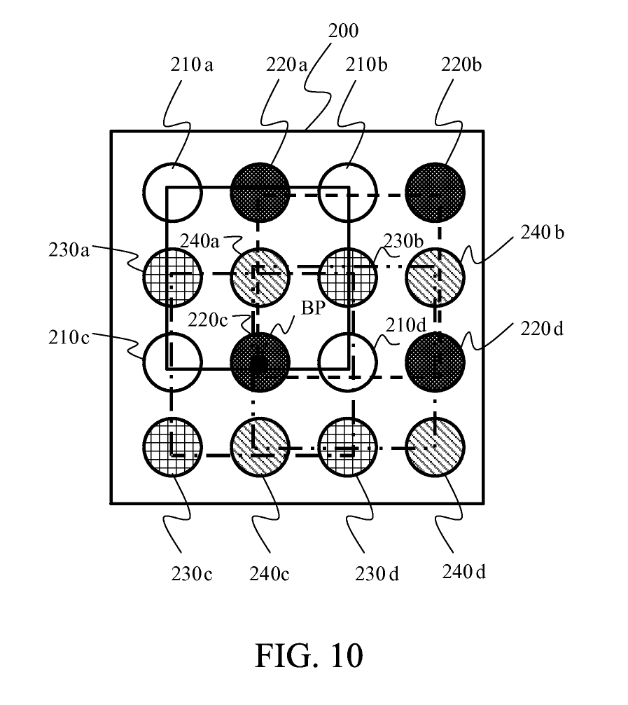

FIG. 10 illustrates an imaging optical unit 200 of a multi-lens image capturing apparatus that is Embodiment 2 of the present invention, which is viewed from its optical axis direction. The imaging optical unit 200 includes multiple first imaging optical systems 210a, 210b, 210c and 210d and multiple second imaging optical systems 220a, 220b, 220c and 220d. The imaging optical unit 200 further includes multiple third imaging optical systems 230a, 230b, 230c and 230d and multiple fourth imaging optical systems 240a, 240b, 240c and 240d. The multiple imaging optical systems 210a to 210d, 220a to 220d, 230a to 230d and 240a to 240d are arranged such that their optical axes are separate from one another in a two-dimensional direction orthogonal to the optical axes. In addition, the optical axes of the imaging optical systems 210a to 210d, 220a to 220d, 230a to 230d and 240a to 240d extend parallel to one another.

The first imaging optical systems 210a to 210d each have a first field angle (focal length) e. The first field angle θ corresponds to a telephoto-end field angle which is a narrowest field angle in the multi-lens image capturing apparatus of this embodiment. The first imaging optical systems 210a to 210d are hereinafter collectively referred to also as “a first imaging optical system group.” Moreover, the second imaging optical systems 220a to 220d each have a second field angle (in this embodiment, 8θ which is eight times as wide as the first field angle θ) wider than the first field angle θ. The second field angle 8θ corresponds to a wide-angle-end field angle which is the widest field angle in the multi-lens image capturing apparatus of this embodiment. The second imaging optical systems 220a to 220d are hereinafter collectively referred to also as “a second imaging optical system group.” The third imaging optical systems 230a to 230d each have a third field angle (in this embodiment, 4θ which is a half of the second field angle 8θ). The third imaging optical systems 230a to 230d are hereinafter collectively referred to also as “a third imaging optical system group.” The fourth imaging optical systems 240a to 240d each have a fourth field angle (in this embodiment, 2θ which is one-fourth of the second field angle 8θ). The fourth imaging optical systems 240a to 240d are hereinafter collectively referred to also as “a fourth imaging optical system group.”

In this embodiment, the first to fourth imaging optical system groups are arranged in a four-by-four matrix in horizontal and vertical directions. Specifically, in a first row and a third row in the vertical direction, the first imaging optical system, the second imaging optical system, the first imaging optical system and the second imaging optical system are arranged in this order in the horizontal direction (from left to right in FIG. 10; the same applies hereinafter). Moreover, in a second row and a fourth row, the third imaging optical system, the fourth imaging optical system, the third imaging optical system and the fourth imaging optical system are arranged in this order in the horizontal direction.

An image sensor unit of the multi-lens image capturing apparatus of this embodiment includes, though not illustrated in the drawing, sixteen image sensors constituting image-capturing areas respectively corresponding to the imaging optical systems 210a to 210d, 220a to 220d, 230a to 230d and 240a to 240d.

In FIG. 10, positions of the optical axes of the first imaging optical system 210a to 210d are connected by solid lines (straight lines) extending in the vertical and horizontal directions. An area surrounded by the solid lines is defined as a first area. Moreover, positions of the optical axes of the second imaging optical systems 220a to 220d are connected by dashed lines (straight lines) extending in the vertical and horizontal directions. An area surrounded by the dashed lines is defined as a second area. Furthermore, positions of the optical axes of the third imaging optical systems 230a to 230d are connected by dashed-dotted lines extending in the vertical and horizontal directions. An area surrounded by the dashed-dotted lines is defined as a third area. Moreover, positions of the optical axes of the fourth imaging optical systems 240a to 240d are connected by dashed double-dotted lines (straight lines) extending in the vertical and horizontal directions. An area surrounded by the dashed double-dotted lines is defined as a fourth area. In FIG. 10, for ease of reference to the solid line, the dashed line, the dashed-dotted line and the dashed double-dotted line, each line is drawn to be slightly displaced from the position of the optical axis of the corresponding imaging optical system.

The first to fourth imaging optical system groups are arranged such that an area exists where all of the first to fourth areas overlap one another (area where the optical axes of the first to fourth imaging optical systems 210d, 220c, 230b and 240a are located at a central area of the imaging optical unit 200). In this embodiment, the second imaging optical system 220c having the widest field angle of those of all the first to fourth imaging optical systems 210d, 220c, 230b and 240a disposed in the area in which all of the first to fourth areas overlap one another is defined as a base optical system, and its position is defined as a base viewpoint BP. The configuration of the multi-lens image capturing apparatus of this embodiment other than the imaging optical unit 200 is same as that in Embodiment 1, and therefor description thereof is omitted.

Similarly to Embodiment 1, the multi-lens image capturing apparatus of this embodiment also performs the image combining process and the intermediate-field angle-image producing process (description of these processes is omitted) by using, as a base image, a captured image provided through the base optical system 220c which is disposed at the base viewpoint BP. This enables reducing object positional shifts in combined images provided through the respective imaging optical system groups when an image-capturing field angle is changed from the field angle of the second imaging optical system group to the field angles of the first, third and fourth imaging optical system groups. In addition, since the optical axis of the base optical system 220c which is disposed at the base viewpoint BP is located in the area where all of the first to fourth areas overlap one another, an object area included in the base image provided through the base optical system 220c is always included in at least one of the captured images provided through the other imaging optical systems. This makes it possible to eliminate an influence of occlusion in image combining using the base image.

Similarly to Embodiment 1, the multi-lens image capturing apparatus of this embodiment also can perform the continuous zooming without being provided with the zoom mechanism which moves the magnification-varying optical element. Furthermore, the multi-lens image capturing apparatus of this embodiment includes a greater number of the imaging optical system groups whose field angles are different from one another, compared to that in Embodiment 1, which makes it possible to easily provide a higher zoom ratio.

Although this embodiment has described a case where a ratio between a wide-angle-side field angle W and a next narrower field angle Wn than the wide-angle-side field angle W among the first to fourth field angles discretely different from one another is 2, this case is merely an example and thus the ratio may be other values. However, even in cases where the ratio is the other value, it is desirable that the above-described condition of expression (1) be satisfied. The same applies to other embodiments described later.

### Embodiment 3

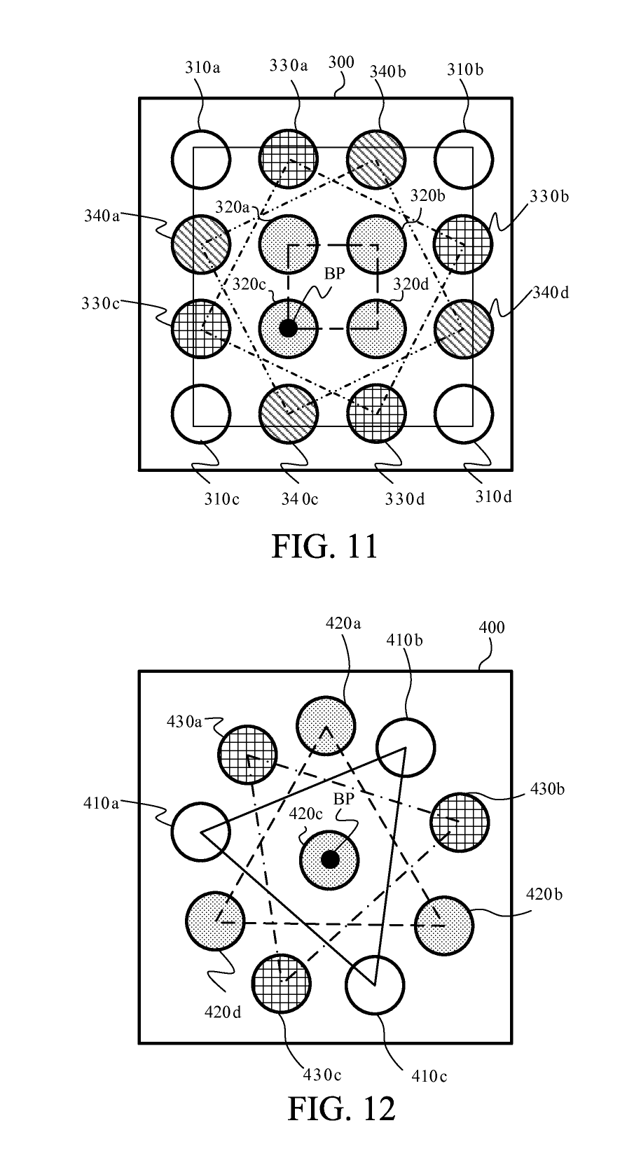

FIG. 11 illustrates an imaging optical unit 300 of a multi-lens image capturing apparatus that is Embodiment 3 of the present invention, which is viewed from its optical axis direction. The imaging optical unit 300 includes multiple first imaging optical systems 310a, 310b, 310c and 310d and multiple second imaging optical systems 320a, 320b, 320c and 320d. The imaging optical unit 300 further includes multiple third imaging optical systems 330a, 330b, 330c and 330d and multiple fourth imaging optical systems 340a, 340b, 340c and 340d. The multiple imaging optical systems 310a to 310d, 320a to 320d, 330a to 330d and 340a to 340d are arranged such that their optical axes are separate from one another in a two-dimensional direction orthogonal to their optical axes. In addition, the optical axes of the imaging optical systems 310a to 310d, 320a to 320d, 330a to 330d and 340a to 340d extend parallel to one another.

The first imaging optical systems 310a to 310d each have a first field angle (focal length) θ. The first field angle θ corresponds to a telephoto-end field angle which is a narrowest field angle in the multi-lens image capturing apparatus of this embodiment. The first imaging optical systems 310a to 310d are hereinafter collectively referred to also as “a first imaging optical system group.” Moreover, the second imaging optical systems 320a to 320d each have a second field angle (in this embodiment, 8θ which is eight times as wide as the first field angle θ) wider than the first field angle θ. The second field angle 8θ corresponds to a wide-angle-end field angle which is a widest field angle in the multi-lens image capturing apparatus of this embodiment. The second imaging optical systems 320a to 320d are hereinafter collectively referred to also as “a second imaging optical system.” The third imaging optical systems 330a to 330d each have a third field angle (in this embodiment, 4θ which is a half of the second field angle 8θ) wider than the first field angle θ and narrower than the second field angle 8θ. The third imaging optical systems 330a to 330d are hereinafter collectively referred to also as “a third imaging optical system group.” The fourth imaging optical systems 340a to 340d each have a fourth field angle (in this embodiment, 2θ which is one-fourth of the second field angle 8θ) wider than the first field angle θ and narrower than the third field angle 4θ. Since the fourth imaging optical systems 340a to 340d also each have the field angle wider than the first field angle θ and narrower than the second field angle 8θ, they can be referred to also as other third imaging optical systems than the third imaging optical systems 330a to 330d. The fourth imaging optical systems 340a to 340d are hereinafter collectively referred to also as “a fourth imaging optical system group.”

In this embodiment, the first to fourth imaging optical system groups are arranged in a four-by-four matrix in horizontal and vertical directions. Specifically, in a first row in the vertical direction, the first imaging optical system, the third imaging optical system, the fourth imaging optical system and the first imaging optical system are arranged in this order in the horizontal direction (from left to right in FIG. 11; the same applies hereinafter). Moreover, in a second row, the fourth imaging optical system, the second imaging optical system, the second imaging optical system and the third imaging optical system are arranged in this order in the horizontal direction. In a third row, the third imaging optical system, the second imaging optical system, the second imaging optical system and the fourth imaging optical system are arranged in this order in the horizontal direction. In the fourth row, the first imaging optical system, the fourth imaging optical system, the third imaging optical system and the fourth imaging optical system are arranged in this order in the horizontal direction.

An image sensor unit of the multi-lens image capturing apparatus of this embodiment includes, though not illustrated in the drawing, sixteen image sensors constituting image-capturing areas respectively corresponding to the imaging optical systems 310a to 310d, 320a to 320d, 330a to 330d and 340a to 340d.

In FIG. 11, positions of the optical axes of the first imaging optical systems 310a to 310d are connected by solid lines (straight lines) extending in the vertical and horizontal directions. An area surrounded by the solid lines is defined as a first area. Moreover, positions of the optical axes of the second imaging optical systems 320a to 320d are connected by dashed lines (straight lines) extending in the vertical and horizontal directions. An area surrounded by the dashed lines is defined as a second area. Furthermore, positions of the optical axes of the third imaging optical systems 330a to 330d are connected by dashed-dotted lines (straight lines) extending in an oblique direction. An area surrounded by the dashed-dotted lines is defined as a third area. Moreover, positions of the optical axes of the fourth imaging optical systems 340a to 340d are connected by dashed double-dotted lines extending in another oblique direction. An area surrounded by the dashed double-dotted lines is defined as a fourth area. In FIG. 11, for ease of reference to the solid line, the dashed line, the dashed-dotted line and the dashed double-dotted line, the solid line is drawn to be slightly displaced from the position of the optical axis of the first imaging optical system group.

The first to fourth imaging optical system groups are arranged such that an area exists where all of the first to fourth areas overlap one another (area where the optical axes of the second imaging optical systems 320a to 320d are located at a central area of the imaging optical unit 300). In this embodiment, the second imaging optical system 320c, which is one of the second imaging optical systems 320a to 320d disposed in the area where all of the first to fourth areas overlap one another and having the widest field angle, is defined as a base optical system, and its position is defined as a base viewpoint BP. The configuration of the multi-lens image capturing apparatus of this embodiment other than the imaging optical unit 300 is same as that in Embodiment 1, and therefore description thereof is omitted.

Similarly to Embodiment 1, the multi-lens image capturing apparatus of this embodiment also performs the image combining process and the intermediate-field angle-image producing process (description of these processes is omitted) by using, as a base image, a captured image provided through the base optical system 320c which is disposed at the base viewpoint BP. This enables reducing object positional shifts in combined images provided through the respective imaging optical system groups when an image-capturing field angle is changed from the field angle of the second imaging optical system group to the field angles of the first, third and fourth imaging optical system groups. In addition, since the optical axis of the base optical system 320c which is disposed at the base viewpoint BP is located in the area where all of the first to fourth areas overlap one another, an object area included in the base image provided through the base optical system 320c is always included in at least one of the captured images provided through the other imaging optical systems. This makes it possible to eliminate an influence of occlusion in image combining using the base image.

Similarly to Embodiment 1, the multi-lens image capturing apparatus of this embodiment also can perform the continuous zooming without being provided with the zoom mechanism which moves the magnification-varying optical element. Furthermore, the multi-lens image capturing apparatus of this embodiment includes a greater number of the imaging optical system groups whose field angles are different from one another, compared to that in Embodiment 1, which makes it possible to easily provide a higher zoom ratio.

### Embodiment 4

FIG. 12 illustrates an imaging optical unit 400 of a multi-lens image capturing apparatus that is Embodiment 4 of the present invention, which is viewed from its optical axis direction. The imaging optical unit 400 includes multiple first imaging optical systems 410a, 410b and 410c and multiple second imaging optical systems 420a, 420b, 420c and 420d. The imaging optical unit 400 further includes multiple third imaging optical systems 430a, 430b and 430c. The multiple imaging optical systems 410a to 410c, 420a to 420d and 430a to 430c are arranged such that their optical axes are separate from one another in a two-dimensional direction orthogonal to the optical axes. In addition, the optical axes of the imaging optical systems 410a to 410c, 420a to 420d and 430a to 430c extend parallel to one another.

The first imaging optical systems 410a to 410c each have a first field angle (focal length) e. The first field angle θ corresponds to a telephoto-end field angle which is a narrowest field angle in the multi-lens image capturing apparatus of this embodiment. The first imaging optical systems 410a to 410c are hereinafter collectively referred to also as “a first imaging optical system group.” Moreover, the second imaging optical systems 420a to 420d each have a second field angle (in this embodiment, 4θ which is four times as wide as the first field angle θ) wider than the first field angle θ. The second field angle 4θ corresponds to a wide-angle-end field angle which is a widest field angle in the multi-lens image capturing apparatus of this embodiment. The second imaging optical systems 420a to 420d are hereinafter collectively referred to also as “a second imaging optical system.” The third imaging optical systems 430a to 430c each have a third field angle (in this embodiment, 2θ which is a half of the second field angle 2θ) wider than the first field angle θ and narrower than the second field angle 4θ. The third imaging optical systems 430a to 430c are hereinafter collectively referred to also as “a third imaging optical system group.”

In this embodiment, the first to third imaging optical system groups are arranged such that, around one second imaging optical system 420c, the other imaging optical systems are arranged in a circle. Specifically, the other imaging optical systems than the second imaging optical system 420c are arranged such that the first imaging optical system, the second imaging optical system and the third imaging optical system are repeatedly arranged in this order in a counterclockwise direction.

An image sensor unit of the multi-lens image capturing apparatus of this embodiment includes, though not illustrated in the drawing, ten image sensors constituting image-capturing areas respectively corresponding to the imaging optical systems 410a to 410c, 420a to 420d and 430a to 430c.

In FIG. 12, positions of the optical axes of the first imaging optical systems 410a to 410c are connected by solid lines (straight lines). An area surrounded by the solid lines is defined as a first area. Moreover, positions of the optical axes of the other second imaging optical systems 420a, 420b and 420d than the second imaging optical system 420c are connected by dashed lines (straight lines). An area surrounded by the dashed lines is defined as a second area. Furthermore, positions of the optical axes of the third imaging optical systems 430a to 430c are connected by dashed-dotted lines (straight lines). An area surrounded by the dashed-dotted lines is defined as a third area.

The first to third imaging optical system groups are arranged such that an area exists where all of the first to third areas overlap one another. In this embodiment, the second imaging optical system 420c which is one of the second imaging optical systems 420a to 420d each having the widest field angle among those of the first to third imaging optical system groups is disposed in the area where all of the first to third areas overlap one another. The second imaging optical system 420c is defined as a base optical system, and its position thereof is defined as a base viewpoint BP.

It is desirable that the base optical system 420c be disposed at a centroid of the positions of the optical axes of all the other imaging optical systems in the area where all of the first to third areas overlap one another (or at a position whose distances from the optical axes of all the other imaging optical systems are equal to one another). Disposing the base optical system 420c at such a position enables preventing parallax amounts of the other imaging optical systems with respect to the base optical system 420c from being excessively increased. Such an excessive increase in parallax amount increases an object positional shift amount and an object deformation amount in the captured image provided through each imaging optical system, which makes it difficult to perform image combining. The configuration of the multi-lens image capturing apparatus of this embodiment other than the imaging optical unit 400 is same as that in Embodiment 1, and therefore description thereof is omitted.

Similarly to Embodiment 1, the multi-lens image capturing apparatus of this embodiment also performs the image combining process and the intermediate-field angle-image producing process (description of these processes is omitted) by using, as a base image, a captured image provided through the base optical system 420c which is located at the base viewpoint BP. This enables reducing object positional shifts in combined images provided through the respective imaging optical system groups when an image-capturing field angle is changed from the field angle of the second imaging optical system group to the field angles of the first and third imaging optical system groups. In addition, since the optical axis of the base optical system 420c which is disposed at the base viewpoint BP is located in the area where all of the first to third areas overlap one another, an object area included in the base image provided through the base optical system 420c is always included in at least one of the captured images provided through the other imaging optical systems. This makes it possible to eliminate an influence of occlusion in image combining using the base image.

Similarly to Embodiment 1, the multi-lens image capturing apparatus of this embodiment also can perform the continuous zooming without being provided with the zoom mechanism which moves the magnification-varying optical element. Furthermore, the multi-lens image capturing apparatus of this embodiment includes a greater number of the imaging optical system groups whose field angles are different from one another, compared to that in Embodiment 1, which makes it possible to easily provide a higher zoom ratio.

Although the above-described embodiments have described the cases where the apparatus includes multiple second imaging optical systems whose field angle is widest, it is enough that the apparatus includes at least one second imaging optical system to be used as the base optical system.

Each of the above-described embodiments (Embodiments 1 to 4) realizes a compact (thin) image capturing apparatus including the first and second imaging optical systems whose field angles are different from each other and therefore being capable of performing zooming without being provided with the zoom mechanism which moves the magnification-varying optical element in the optical axis direction. In addition, the optical axes of the second imaging optical systems are arranged in the first area surrounded by the lines connecting the positions of the optical axes of the multiple first imaging optical systems. This arrangement makes it possible to change, with a good accuracy, the viewpoints of the captured images provided through the multiple first imaging optical systems by using, as the base, the captured image provided through the second imaging optical system, which enables reducing the object positional shift due to the switching of the field angle even when image capturing of a three-dimensional object is performed.

A principal aim of the following fifth to seventh embodiments (Embodiments 5 to 7) is to provide a multi-lens image capturing apparatus capable of easily acquiring accurate object side marginal space information for an object space to be captured while having a reduced thickness and a high magnification ratio.

First, description will be made of a method of realizing the continuous zooming performed in the multi-lens image capturing apparatus. A method (hereinafter referred to as “digital zooming”) is known which trims part of a captured image provided by an image capturing apparatus and then enlarges the trimmed part to a predetermined size so as to virtually provide a same effect as that of optical zooming. Moreover, a method is conventionally known which combines the digital zooming and optical zooming to achieve a higher magnification ratio. For instance, application of this method enables interpolating, by the above-described digital zooming, mutually different field angles of the imaging optical systems included in the multi-lens image capturing apparatus to virtually provide the same effect as that of the optical zooming. However, since such a conventional digital zoom method uses linear interpolation (bilinear interpolation), a digital-zoomed image area may be degraded. The bilinear interpolation is a method performing, as a basic concept, interpolation using a sinc function based on a sampling theorem. The bilinear interpolation performs, in order to reduce a calculation load, convolution of an interpolation function approximating the sinc function on sample points of an original image to interpolate between the sample points and thereby increase or decrease number of pixels. The bilinear interpolation advantageously provides a smoothing effect to makes jaggy unnoticeable, but disadvantageously provides, by the smoothing effect, an entirely blurred image whose edge portion where does not meet an assumed condition for the interpolation is mainly smoothed. Furthermore, a problem is known that a high digital zoom ratio decreases quality (resolution) of the zoomed image. It is thus demanded that the decrease in resolution caused by the digital zoom method be improved to produce zoomed-image data with a high resolution.

As techniques which meet the demand for cancelling the degradation in resolution caused by the digital zooming, various methods of the super resolution process have been conventionally proposed.

The exemplary methods of the super resolution process includes, as described above, the ML (Maximum-Likelihood method, the MAP (Maximum A Posterior) method, the POCS (Projection Onto Convex Set) method, an IBP (Iterative Back Projection) method and an LR (Lucy-Richardson) method. For instance, the LR method normalizes an illuminance distribution of an original image and that of a degraded image to regard each of the normalized distributions as a distribution of a probability density function. With this LR method, a point spread function (PSF) which is a transfer function of an optical system can be regarded as a distribution of a probability density function of a conditional probability. Then, a distribution of the original image is estimated by iterative calculation for maximum likelihood estimation using the distribution of the degraded image and that of the PSF, on a basis of a Bayesian statistics.

Next, a method of restoring an image on the basis of the Bayesian statistics will be described. Description will be made below of a case of a monochrome one-dimensional image for simplicity of description. In this case, an object is referred to as “an original image”, a captured image provided through an optical system by the image-capturing apparatus or an enlarged image provided by electrical enlargement of the captured image is referred to as “a degraded image”, and restoring the degraded image to provide an image approximate to the original image is referred to as “a super-resolution technique”. Moreover, the image restored is referred to as “a high resolution image (restored image)”.

When g(x) represents the degraded image expressed by a one-dimensional vector, and f(x) represents the original image expressed by a one-dimensional vector with respect to the degraded image, the two images satisfy a relation represented by following expression (3):

g(x)=h(x)*f(x) (3)

In expression (3), h(x) represents a PSF which is a transfer characteristic of the optical system, and “*” represents convolution.

On the other hand, the Bayesian statistics is a method which calculates, from a forward process in which the original image f(x) is converted into the degraded image g(x), by using a Bayesian formula, a probability for a reverse process, namely a posterior probability, and which estimates the original image from the degraded image on a basis of the posterior probability. When P(f(x)) represents a probability density function of an event in which the original image f(x) exists, P(g(x)) represents a probability density function of an event in which the degraded image g(x) is produced, and P(g(x)|f(x)) represents a conditional probability density function of the degraded image g(x) when the original image f(x) is given, a relational expression called the Bayesian formula is:

$$P ( f ( x ) \vert g ( x ) ) = \frac{P ( g ( x ) \vert f ( x ) ) P ( f ( x ) )}{P ( g ( x ) )} \qquad ( 4 )$$

In expression (4), P(f(x)|g(x)) represents a conditional probability density distribution for the original image f(x) on a condition that the degraded image g(x) is given and is referred to as “a posterior probability density function”.

In a case where the Bayesian formula based on the above-described Bayesian statistics holds for the original image f(x) and the degraded image g(x), and thereby the original and degraded images f and g can be each considered as being normalized and each treated as a probability density function, an event f(x₁) in which a point light source is located at a coordinate x₁ of the original image f and an event g(x₂) in which an image is formed on a certain coordinate x₂ of the degraded image g(x) can be expressed as follows:

P(f(x₁))=f(x₁) (5)

P(g(x₂))=g(x₂) (6)

Furthermore, by using h which is the PSF of the optical system, P(g(x₂)|f(x₁)) is expressed as:

P(g(x₂)|f(x₁))=h(x₂−x₁) (7)

That is, from expressions (4), (5), (6) and (7), a distribution of the original image f(x) to be formed on the certain coordinate x₂ in the degraded image g(x) can be estimated from:

$$P ( f ( x ) \vert g ( {x}_{2} ) ) = \frac{h ( {x}_{2} - x ) f ( x )}{g ( {x}_{2} )} \qquad ( 8 )$$

Furthermore, following expression (9) holds on the basis of definition of a marginal probability:

P(g(x))=∫_{-∞}^{∞}P(f(x),g(x))dx=∫_{-∞}^{∞}P(g(x)|f(x))P(f(x))dx (9)

That is, expression (8) is expressed alternatively as:

$$\begin{matrix}P ( f ( x ) \vert g ( {x}_{2} ) ) = \frac{h ( {x}_{2} - x ) f ( x )}{{\int }_{- ∞}^{∞} P ( g ( {x}_{2} ) \vert f ( {x}_{1} ) ) P ( f ( {x}_{1} ) ) d {x}_{1}} \\ = \frac{h ( {x}_{2} - x ) f ( x )}{{\int }_{- ∞}^{∞} h ( {x}_{2} - {x}_{1} ) f ( {x}_{1} ) ) d {x}_{1}}\end{matrix} \qquad ( 10 )$$

Multiplying both sides of expression (8) by P(g(x₂))=g(x₂) and performing integration results in, on a basis of the definition of the marginal probability, the left side of expression (8) represented as:

∫_{-∞}^{∞}P(f(x)|g(x₂))P(g(x₂))dx₂=P(f(x))=f(x) (11)

and the right side of expression (8) represented as:

$$f ( x ) {\int }_{- ∞}^{∞} \frac{h ( {x}_{2} - x ) g ( {x}_{2} )}{{\int }_{- ∞}^{∞} h ( {x}_{2} - {x}_{1} ) f ( {x}_{1} ) ) d {x}_{1}} d {x}_{2} \qquad ( 12 )$$

The above-described relation holds when f(x) is a true original image. That is, calculating the f(x) is equivalent to restoration of the original image from the degraded image.

Substituting fₖ₊₁(x) into f(x) of expression (11) and substituting fₖ(x) into f(x) of expression (12) results in following expression (13):

$${f}_{k + 1} ( x ) = {f}_{k} ( x ) {\int }_{- ∞}^{∞} \frac{h ( {x}_{2} - x ) g ( {x}_{2} )}{{\int }_{- ∞}^{∞} h ( {x}_{2} - {x}_{1} ) f ( {x}_{1} ) ) d {x}_{1}} d {x}_{2} \qquad ( 13 )$$

Performing iterative calculation for the above expression (13) enables acquiring a converged value of fₖ(x), namely, the distribution of the original image f(x).

The above description shows that using the restoration method based on the Bayesian statistics enables restoration of an unknown original image if the degraded image and the transfer characteristic of the optical system are known. In addition, from a similar principle to the above-described one, it is possible to restore the transfer characteristic of the optical system if the degraded image and the original image corresponding thereto are known. Moreover, although the PSF is regarded as the transfer characteristic of the optical system in the above description, it is possible to restore, by using Fourier transform, an optical transfer function (OTF) with consideration of an accurate phase characteristic.

When a MAP method is used as another method, a method is used which calculates f(x) which maximizes a posterior probability density shown below:

f(x)=argmaxP(f(x)|g(x)∞P(g(x)|f(x))P(f(x)) (14)

When a Gaussian noise n is assumed to be added to the degraded image and h(x) given as the PSF of the above-described optical system is treated as an m×m convolution matrix C which acts linearly, the degraded image and the original image are expressed also as:

g(x)=C×f(x)+n (15)

In expression (15), the matrix C is not limited to only the PSF, and may be a matrix containing a degradation factor caused by an image capturing system.

On a basis of the above-described assumption, from the proportional expression (14), calculating f(x) which maximizes the posterior probability density in expression (12) is equivalent to calculating f(x) which minimizes the following evaluation function minimum.

T(f)=//g(x)−C×f(x)//²+αZ(f) (16)

In expression (16), Z(f) represents a constraint function containing a constraint term provided from smoothness of image, an additional condition and the like, and a represents a weighting coefficient. Minimizing the above-described evaluation function can be performed by using a conventional steepest descent method or the like.

Calculating f(x) which minimizes a result of expression (16) is equivalent to restoration of the original image from the degraded image.

The restoration of the original image from the degraded image by using the above-described estimation expression (expression (13)) and the evaluation function (expression (16)) requires setting an initial estimation distribution f. It is common that the degraded image g(x) whose image-capturing magnification coincides with that of the restored image is used as the initial estimation distribution. In addition, the transfer characteristic of the optical system such as PSF and OTF and the constraint term acquired from the additional condition, constraint condition and the like are important. However, since the transfer characteristic of the optical system depends on aberration of the optical system and parameters such as an illumination wavelength and an aperture characteristic of the image sensor, it is generally difficult to accurately evaluate the transfer characteristic. For this reason, a Gaussian distribution or the like is simply used as the PSF of the initial condition. However, it is rare that a PSF of an actual image-capturing system coincides with the Gaussian distribution, and thereby, in most cases, using the Gaussian distribution increases an estimation error. In addition, as described above, the PSF from the degraded image can be calculated in principle. However, since the degraded image lacks much required information, it is also difficult to estimate an accurate PSF.

For this reason, it is desirable to improve accuracy of the super-resolution technique by adding an additional strong constraint condition to the super-resolution technique. In this description, a high-resolution image whose image-capturing magnification is different from that of the degraded image to be restored is set as the above-described strong constraint condition. The image whose image-capturing magnification is different means, for example, as illustrated in FIG. 22, when assuming an image 620b which is a partial area of a captured image 620a provided by image capturing of an object as an enlarged degraded image to be restored, a captured image 620c provided by magnified image capturing of an area surrounded by a dashed line in the object captured image 620a with a field angle for the same object is changed.

Using the high-resolution image whose image-capturing magnification is different as described above enables acquiring detailed information in the partial area in the degraded image. This makes it possible to perform a more accurate estimation, on a basis of the high-resolution image, the PSF of a central area of the degraded image in which a main object is present, which enables more accurate restoration by the iterative calculation of expression (13) compared to the conventional methods. Moreover, since the detailed information in the partial area of the degraded image is acquired in advance, adding to a constraint function of expression (16) a correlation function whose evaluation value is a correlation between the high-resolution image and the partial area of the degraded image enables more accurate restoration. The above-described principle clearly shows that acquiring the detailed information in a possible large area in the degraded image enables more accurate restoration. That is, in order to realize the continuous zooming in the multi-lens image capturing apparatus, it is important for the apparatus to include multiple imaging optical systems whose field angles are different from one another.

Next, description will be made of a principle of calculating the object distance in the multi-lens image capturing apparatus. FIG. 23 explains a model of a conventional multi-lens image-capturing method. In a coordinate system in FIG. 23, a center between a left camera L_camera and a right camera R camera is an origin, an x axis extends in a horizontal direction, and a y axis extends in a vertical direction. A height direction is omitted for simplicity. Principal points of imaging optical systems of the left and right cameras are respectively located at (−Wc,0) and (Wc,0). In this configuration, f represents a focal length of each imaging optical system. When a captured image of an object A located at (0,y1) is provided by the cameras, image-capturing parallax amounts Plc and Prc that are shift amounts of the object A in the captured images from the center between the left and right cameras are respectively expressed by following expressions (17) and (18):

$$\begin{matrix}Prc = \frac{wc}{y 1} \cdot f & ( 17 ) \\ Plc = - \frac{wc}{y 1} \cdot f & ( 18 )\end{matrix}$$

From the above-described principle, image capturing of the same object A from mutually different viewpoints enables providing left and right parallax images each having the shift amounts (image-capturing parallax amounts) Plc and Prc represented by above expressions (17) and (18) in a direction where principal point positions are shifted (that is, in a baseline direction). A distance y1 to the object A can be calculated from the shift amounts Plc and Prc by following expression (19):

$$y 1 = \frac{2 wc}{Prc - Plc} \cdot f \qquad ( 19 )$$

Since the above-described image-capturing parallax amounts Plc and Prc are actually acquired according to a resolution corresponding to a pixel size of the image sensor, an error in the object distance calculation increases as the image-capturing parallax amounts Plc and Prc become close to the pixel size. That is, it is important to provide possible large image-capturing parallax amounts in order to improve accuracy in calculating the object distance in the multi-lens image capturing apparatus.

To achieve such an improved accuracy in calculating the object distance, each of Embodiments 5 to 7 additionally proposes an image capturing apparatus which includes at least three optical systems having field angles different from one another and arranged such that paired optical systems having a widest field angle of those of all the optical systems have a longest base length.

### Embodiment 5

A multi-lens image capturing apparatus according to a fifth embodiment (Embodiment 5) of the present invention will be described with reference to the attached drawings.

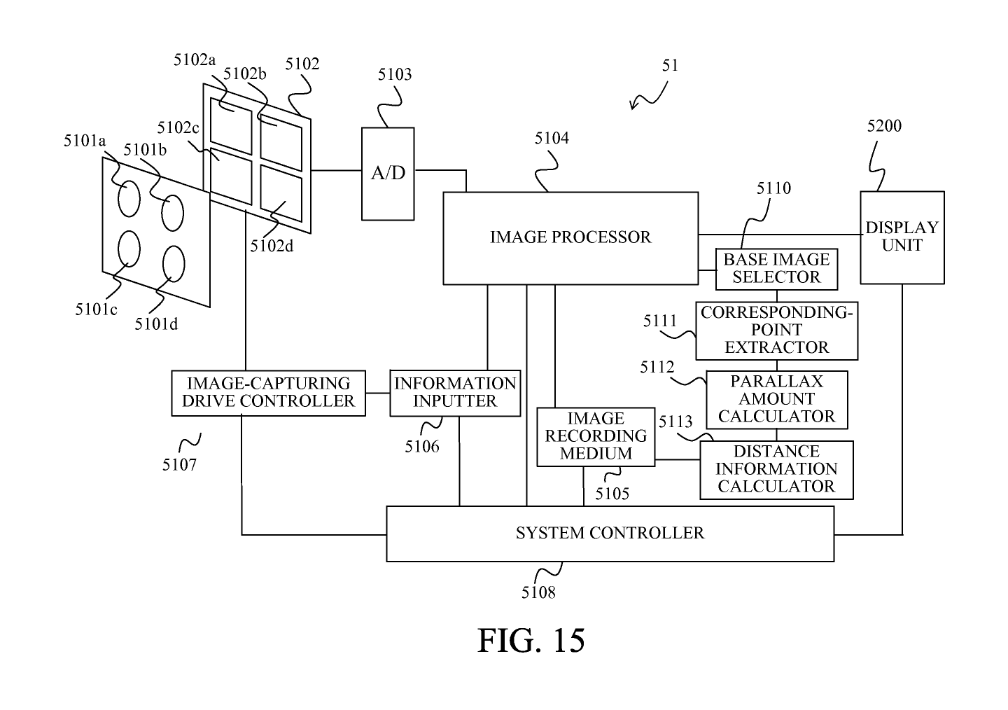

FIG. 15 illustrates a configuration of a multi-lens image capturing apparatus 51 of Embodiment 5. Multiple imaging optical systems 5101a, 5101b, 5101c and 5101d constitute multiple lenses. As illustrated in FIG. 15, an image sensor 5102 includes image-capturing areas 5102a, 5102b, 5102c and 5102d. The image-capturing areas 5102a to 5102d respectively correspond to the imaging optical systems 5101a to 5101d. Each of the image-capturing areas 5102a to 5102d converts an optical image formed by light reaching its light-receiving surface via each of the corresponding imaging optical systems 5101a to 5101d into an analog signal. An A/D converter 5103 converts the analog signal output from the image sensor 5102 into a digital signal and then supplies the digital signal to an image processor 5104.

The image processor 5104 performs predetermined processes such as a pixel interpolation process and a color conversion process on the digital signal (image data) from the A/D converter 5103. As described later, the image processor 5104 as an image restorer also performs an image restoration process which restores an original image from a degraded image. In addition, the image processor 5104 performs a predetermined calculation by using data of captured images. An acquired calculation result is supplied to a system controller 5108. An information inputter 5106 detects information on a desired image-capturing condition selected and input by a user and supplies data thereof to the system controller 5108. The system controller 5108 controls an image-capturing drive controller 5107 on a basis of the supplied data and acquires intended images.

An image recording medium 5105 stores multiple captured still images and motion images and further stores a file header when creating an image file. A display unit 5200 includes, for example, a display device constituted by a liquid crystal display. A base image selector 5110 selects a base image from multiple parallax images provided through the imaging optical systems 5101a, 5101b, 5101c and 5101d. A corresponding point extractor 5111 extracts corresponding pixels in the parallax images. A parallax amount calculator 5112 calculates a parallax amount for all the corresponding points extracted by the corresponding point extractor 5111. A distance information calculator 5113 calculates object distance information from the calculated parallax amount.

As illustrated in FIG. 15, the multi-lens image capturing apparatus 51 includes the four imaging optical system 5101a, 5101b, 5101c and 5101d. The four imaging optical systems 5101a to 5101d are arranged such that their optical axes are separate from one another and are parallel to one another. The expression “the optical axes are parallel to one another” means a state where the optical axes are perfectly parallel to one another and a state where the optical axes are shifted from the perfectly parallel state within a permissible tolerance. The same applies to subsequent embodiments.

Moreover, the four imaging optical systems 5101a to 5101d are arranged such that baselines connecting the optical axes thereof orthogonally intersect with one another. Furthermore, the imaging optical systems (first optical system and second optical system) 5101a and 5101d arranged at diagonal vertex positions in a diagonal direction are configured as paired wide-angle-imaging-optical-system pair having a widest image-capturing field angle (first field angle) 40 among all of the imaging optical systems 5101a to 5101d. Furthermore, the imaging optical system (third optical system) 5101b is configured to have an image-capturing field angle 2θ (second field angle narrower than the first field angle 4θ) which is half of that of the imaging optical systems 5101a and 5101d. In addition, the imaging optical system (fourth optical system) 5101c is configured to have an image-capturing field angle θ (third field angle narrower than the second field angle 2θ) which is half of that of the imaging optical system 5101b.

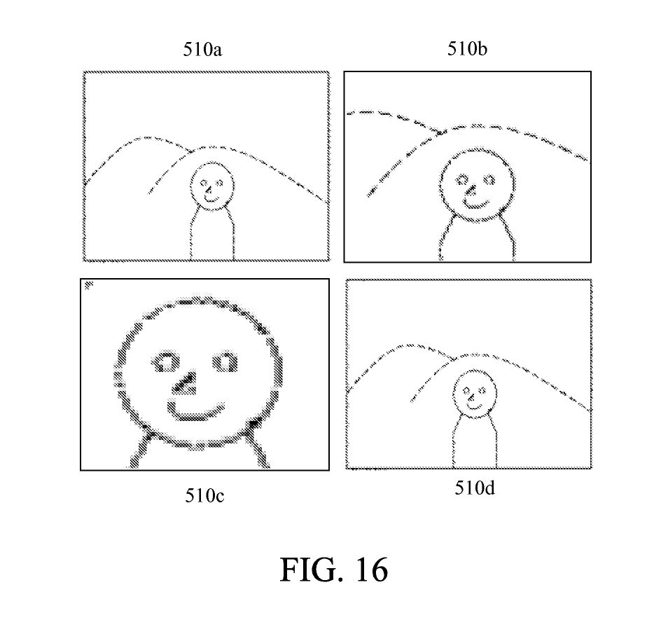

For ease of description, FIG. 16 illustrates captured images 510a, 510b, 510c and 510d corresponding to the imaging optical systems 5101a to 5101d arranged as above. The captured image 510a is a first image provided from the image-capturing area (first image-capturing area corresponding to the first optical system) 5102a of the image sensor 5102. The captured image 510d is a second image provided from the image-capturing area (second image-capturing area corresponding to the second optical system) 5102d of the image sensor 5102. The captured image 510b is a third image provided from the image-capturing area (third image-capturing area corresponding to the third optical system) 5102b of the image sensor 5102. The captured image 510c is a fourth image provided from the image-capturing area (fourth image-capturing area corresponding to the fourth optical system) 5102c of the image sensor 5102. As illustrated in FIG. 16, the captured images 510a and 510d corresponding to the imaging optical systems 5101a and 5101d are provided by image capturing of a widest object space, and the captured images 510b and 510c corresponding to the imaging optical systems 5101b and 5101c are provided by image capturing of a narrower object space than the widest object space.

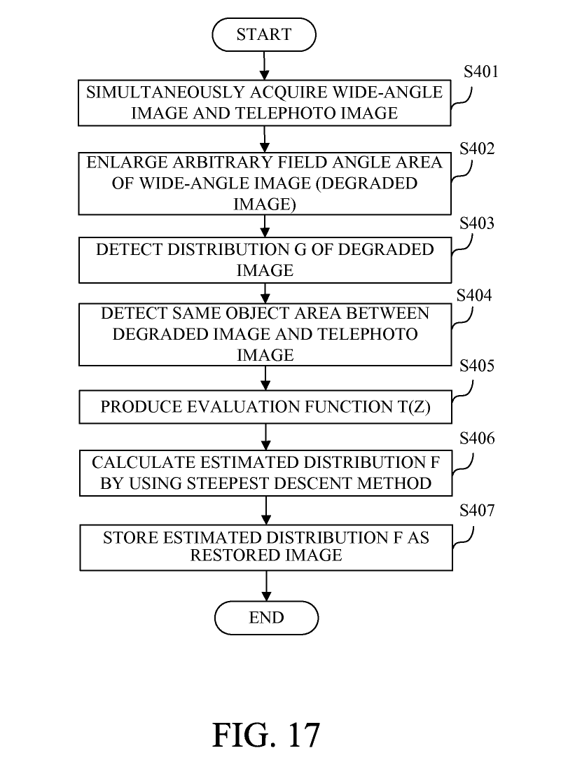

Detailed description will be made of an image-capturing operation which realizes the continuous zooming in the multi-lens image capturing apparatus 51, with reference to a flowchart of FIG. 17. First, at step S401, in response to a user's input of an instruction signal for starting image capturing, the system controller 5108 simultaneously acquires a wide-angle image (first image) provided by image capturing of the widest object space and a telephoto image (third image) provided by image capturing of the narrower object space than the widest object space. At this step, for example, the system controller 5108 acquires the wide-angle image 510a (first image) and the telephoto image 510b (third image) shown in FIG. 16. Since the first and third images 510a and 510b are captured images at a wide-angle zoom position and a telephoto zoom position where optical characteristics are ensured, the first and third images 510a and 510b each have a sufficiently high resolution. The first image 510a includes at least part (desirably all) of the third image 510b.

Next, at step S402, the image processor 5104 clips, from the first image, an image area of a user's arbitrary field angle and enlarges the image area. The enlarged image is a degraded image because it is enlarged using a linear interpolation which is a conventional digital zoom technique. In this embodiment, the degraded image (enlarged image) is an image whose field angle is intermediate between the first field angle and the second field angle. In other words, the degraded image includes at least part (desirably all) of the third image 510b.

Next, at step S403, the image processor 5104 detects a distribution g of the degraded image. Next, at step S404, the image processor 5104 detects, in the degraded image, an image area (hereinafter referred to as “a same object area”) where a same object is included as that included in the third image 510b which is a reference image. In detecting the same object area, the block matching method described in Embodiment 1 or the like may be used. Additionally, in detecting the same object area, the image processor 5104 may reduce a size of the reference image (third image) 510b to a same size as that of the degraded image or may enlarge the degraded image to make a comparison with the reference image 510b.

Next, the image processor 5104 performs the super-resolution process. In this process, at step S405, the image processor 5104 creates an evaluation function T(f) represented by expression (16). In this embodiment, the image processor 5104 adds, to the term Z(f) of the evaluation function T(f), a correlation function whose value decreases as the same object areas of the degraded image and the reference image 510b described above have a higher correlation, thereby enabling higher accurate image restoration than conventional one. Since the degraded image and the reference image 510b are each provided by image capturing of the same object, the following relation is satisfied where β1 represents an image-capturing magnification of the degraded image and β2 represents an image-capturing magnification of the reference image 510b:

β1<β2

The reference image 510b satisfying such a relation contains a higher frequency component of the object, which makes it possible to restore even the high frequency component of the reference image 510b with high accuracy.

Next, at step S406, the image processor 5104 calculates an estimated distribution f in which the evaluation function T(f) has the minimum value, by using the steepest descent method or the like.

Next, at step S407, the image processor 5104 stores a restored image having the calculated estimated distribution f and then ends this process.

The display unit 5200 displays a displaying image produced by performing a predetermined displaying process on the restored image, a corrected image produced by performing a simple correction process on the restored image, or a non-processed restored image. In addition, the display unit 5200 may display the first image in image capturing for allowing the user to select, after or during the image capturing, a desired field angle and to start the above-described process. A correction amount in the correction process may be decided, since it depends on a permissible amount set for the displaying image, depending on an intended image quality level or a processing load amount.

Moreover, using as a first image and a third image the telephoto image 510b and a further telephoto side image 510c enables continuous zooming to a higher magnification area. Although, in this embodiment, the imaging optical systems having the different field angles adjacent to each other are configured such that a field angle ratio between a wide-angle side field angle and a telephoto side field angle is 2, this ratio is merely an example for ease of description. It is desirable that following expression (20) be satisfied where W represents a field angle of an arbitrary imaging optical system constituting part of the multiple imaging optical systems and Wn represents a field angle of the imaging optical system which is a next narrower field angle than the field angle W:

1.1<W/Wn<3 (20)

A lower value than the lower limit of expression (20) requires a significantly large number of the imaging optical systems to achieve the image-capturing apparatus with a high magnification ratio, resulting in an increase in size of the apparatus. A higher value than the upper limit of expression (20) makes it difficult to perform image restoration with high accuracy even by using the above-described super-resolution technique, which degrades quality of a zoomed image.

This embodiment using the multiple imaging optical systems whose field angles are different from one another as described above enables the continuous zooming with ensuring a sufficient resolution without requiring a zoom mechanism and the like, which can contribute to reduction in thickness of the multi-lens image capturing apparatus.

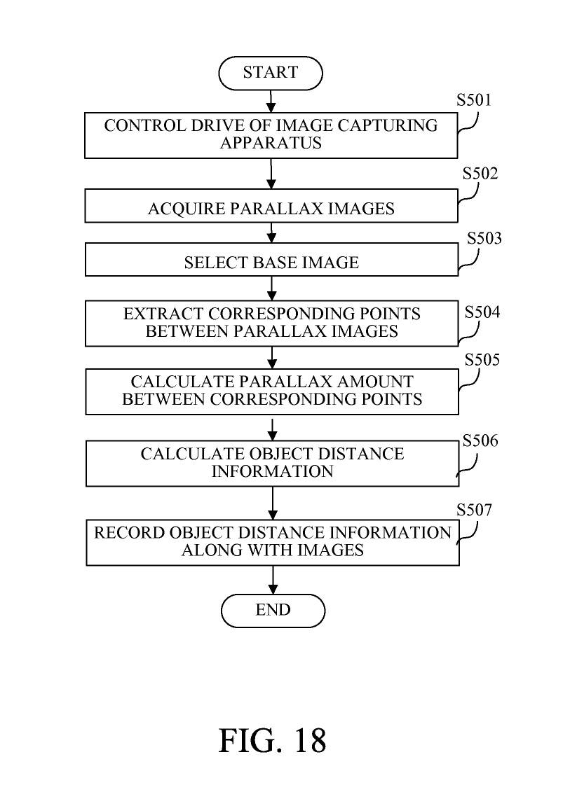

Next, an object-distance-information recording operation of the multi-lens image capturing apparatus 51 of this embodiment will be described in detail with reference to a flowchart of FIG. 18. First, description will be made of an operation performed when parallax images provided through the imaging optical systems 5101a and 5101d each capturing the widest object space are used. First of all, in response to the user's input of the instruction signal for starting image capturing, the system controller 5108 starts, at step S501, drive control of the entire image-capturing apparatus 1. Next, at step S502, the system controller S108 causes the image sensor 5102 to photoelectrically convert the optical images formed through the imaging optical systems 5101a and 5101d and to transfer the signal output from the image sensor 5102 via the A/D converter 5103 to the image processor 5104. The image processor 5104 performs the predetermined processes on the transferred signal to acquire captured images as the parallax images.

Next, at step S503, the base image selector S110 selects one of the parallax images as a base image for calculating a parallax amount. In this embodiment, the base image selector S110 selects the captured image provided through the imaging optical system 5101a as the base image (first image).

Next, at step S504, the corresponding-point extractor 5111 extracts corresponding pixels (corresponding points) between the selected base image and the captured image provided through the imaging optical system 5101d as a reference image (second image). The corresponding pixels in this embodiment are, for example, paired pixels corresponding to a same point in a same object A in the parallax images acquired by image capturing of the object A through the different imaging optical systems. A method of extracting the corresponding pixels at this step is same as that described in Embodiment 1 with reference to FIG. 6.

Next, at step S505, the parallax amount calculator 5112 calculates parallax amounts of the respective paired corresponding pixels extracted as described above. Specifically, the parallax amount calculator 5112 calculates the parallax amount as a pixel position difference (corresponding to Prc-Plc in expression (19)) between the corresponding pixels in the base and reference images 501 and 502 extracted by the above-described block matching method.

Next, at step S506, the distance information calculator 5113 calculates information on distances to objects (object distances) to be captured from the parallax amounts calculated as described above and from a focal length and a base length of the imaging optical systems 5101a and 5101d, both of which are known information, by using expression (19). As described above, in order to improve accuracy in calculating the object distance, it is important that a possible large image-capturing parallax amount is provided. On the other hand, for the user, the distance information in the entire object space to be captured is important.

For this reason, this embodiment has a configuration in which, among all the imaging optical systems, the wide-angle imaging optical systems 5101a and 5101d for image capturing of the widest object space are arranged diagonally such that they have a longest base length. In addition, although this embodiment has described the distance information calculation performed when the paired imaging optical systems 5101a and 5101d are used, it is possible to calculate the distance information on a basis of a similar principle by alternatively using other paired imaging optical systems (for example, the optical systems 5101a and 5101b). When the above-described method is used for images whose field angles are different from each other, it is more desirable to clip a portion corresponding to a narrower field angle image from a wider field angle image to extract the corresponding points.

Next, at step S507, the system controller S108 records the acquired images with the calculated object distance information and then ends this process.

As described above, the multi-lens image capturing apparatus of this embodiment including the three types of imaging optical systems whose field angles are different from one another makes it possible to realize the continuous zooming without requiring a zoom mechanism and the like. Furthermore, the image capturing apparatus of this embodiment includes the paired wide-angle imaging optical systems for image capturing of the widest object space among all the imaging optical systems and arranges the paired wide-angle imaging optical systems diagonally such that the base length therebetween is longest, thereby also achieving an improvement in accuracy in acquiring the distance information. That is, the configuration of this embodiment makes it possible to achieve an image-capturing apparatus, such as a video camera and a digital camera, having a reduced thickness and a high magnification ratio and being capable of easily acquiring accurate object side marginal space information for an object space to be captured.

### Embodiment 6

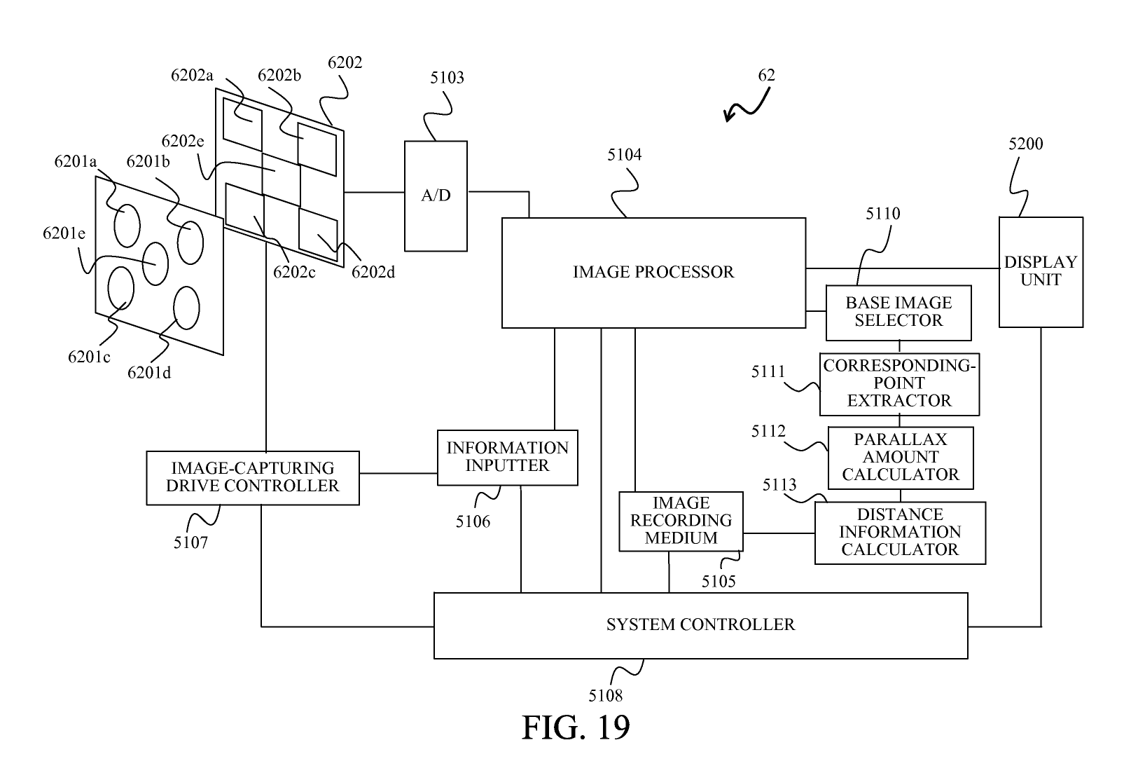

A multi-lens image capturing apparatus of Embodiment 6 of the present invention will be described below with reference to FIG. 19.

FIG. 19 illustrates a configuration of the multi-lens image capturing apparatus 62 of Embodiment 6. Multiple imaging optical systems 6201a, 6201b, 6201c, 6201d and 6201e constitute multiple lenses. An image sensor 6202 includes image-capturing areas 6202a, 6202b, 6202c, 6202d and 6202e respectively corresponding to the imaging optical systems 6201a to 6201e. The image-capturing areas 6202a to 6202e each convert an optical image formed by light reaching a light-receiving surface thereof through the corresponding imaging optical systems 6201a to 6201e into an electrical signal. Other elements with the same reference numeral are same as those of Embodiment 5, so that description thereof is omitted.

As illustrated in FIG. 19, the multi-lens image capturing apparatus 62 includes the five imaging optical systems 6201a, 6201b, 6201c, 6201d and 6201e. The five imaging optical systems 6201a to 6201e are arranged such that their optical axes are separate from each other and are parallel (or approximately parallel) to one another. In addition, the five imaging optical systems 6201a to 6201e are arranged such that baselines connecting the optical axes of the imaging optical systems 6201a to 6201e intersect with one another; the optical axes of part of the imaging optical systems 6201a to 6201e orthogonally intersect with one another. Furthermore, the imaging optical systems 6201a and 6201d arranged in a diagonal direction constitute paired wide-angle imaging optical systems having a widest image-capturing field angle 8θ among those of the five imaging optical systems.

Moreover, the imaging optical system 6201b has an image-capturing field angle 4θ, which is half of that of the imaging optical systems 6201a and 6201d. The imaging optical system 6201e has an image-capturing field angle 2θ, which is half of 4θ, and the imaging optical system 6201c has an image-capturing field angle θ, which is half of 2θ.

Since means for realizing the continuous zooming and the configuration to improve accuracy in acquiring the distance information are same as those of Embodiment 5, detailed description thereof is omitted in this embodiment.

As described above, the multi-lens image capturing apparatus of this embodiment including the four types of imaging optical systems whose field angles are different from one another makes it possible to realize the continuous zooming without requiring a zoom mechanism and the like. Furthermore, the image capturing apparatus of this embodiment includes the paired wide-angle imaging optical systems for image capturing of the widest object space among all the imaging optical systems and arranges the paired wide-angle imaging optical systems diagonally such that the base length therebetween is longest, thereby also achieving an improvement in accuracy in acquiring the distance information.

That is, the configuration of this embodiment makes it possible to achieve an image-capturing apparatus, such as a video camera and a digital camera, having a reduced thickness and a high magnification ratio and being capable of easily acquiring accurate object side marginal space information for an object space to be captured.

### Embodiment 7

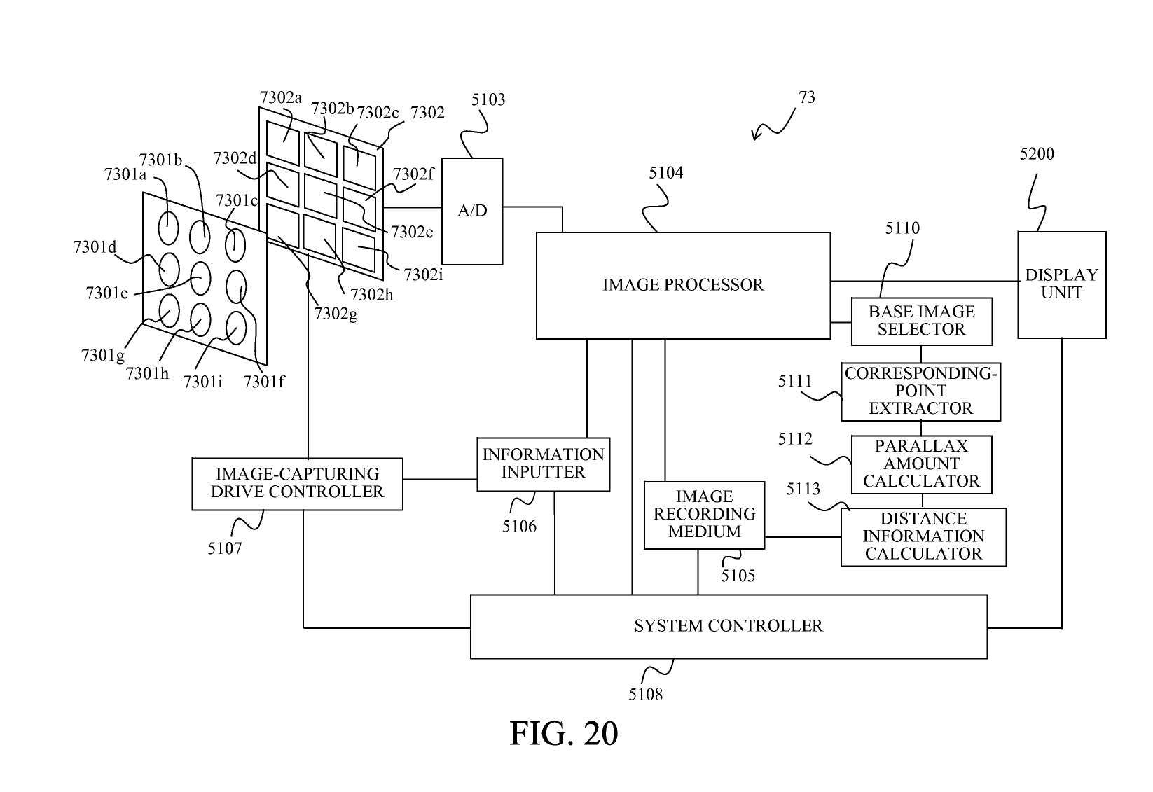

A multi-lens image capturing apparatus of Embodiment 7 of the present invention will be described below with reference to FIG. 20.

FIG. 20 illustrates a configuration of the multi-lens image capturing apparatus 73 of Embodiment 7. Multiple imaging optical systems 7301a, 7301b, 7301c, 7301d, 7301e, 7301f, 7301g, 7301h and 7301i constitute multiple lenses. An image sensor 7302 includes image-capturing areas 7302a, 7302b, 7302c, 7302d, 7302e, 7302f, 7302g, 7302h and 7302i respectively corresponding to the imaging optical systems 7301a to 7301i. The image-capturing areas 7302a to 7302e each convert an optical image formed by light reaching a light receiving surface thereof through the corresponding imaging optical systems 7301a to 7301i into an electrical signal. Other elements with the same reference numeral are same as those of Embodiment 5, so that description thereof is omitted.

As illustrated in FIG. 20, the multi-lens image capturing apparatus 73 includes the nine imaging optical systems 7301a, 7301b, 7301c, 7301d, 7301e, 7301f, 7301g, 7301h and 7301i. The nine imaging optical systems 7301a to 7301i are arranged such that their optical axes are separate from one another and are parallel (or approximately parallel) to one another. In addition, the nine imaging optical systems 7301a to 7301i are arranged such that baselines connecting the optical axes of the imaging optical systems 7301a to 7301i orthogonally intersect with one another. Furthermore, the imaging optical systems 7301a and 7301i arranged in a diagonal direction constitute paired wide-angle imaging optical systems having a widest image-capturing field angle 8θ among those of all the nine imaging optical systems. Moreover, the imaging optical system 7301b has an image-capturing field angle 7θ, the imaging optical system 7301c has an image-capturing field angle 6θ, the imaging optical system 7301f has an image-capturing field angle 5θ, the imaging optical system 7301e has an image-capturing field angle 4θ, the imaging optical system 7301d has an image-capturing field angle 3θ, the imaging optical system 7301g has an image-capturing field angle 2θ, and the imaging optical system 7301h has an image-capturing field angle θ.

Since means for realizing the continuous zooming and the configuration to improve an accuracy in acquiring the distance information are same as those of Embodiment 5, detailed description thereof is omitted in this embodiment. In addition, in this embodiment, the imaging optical systems having a wide-angle side field angle and a telephoto-side field angle adjacent to each other are configured to provide a field angle ratio from 1.14 to 2. However, this ratio is merely an example for ease of description. It is desirable that, also in this embodiment, above-described expression (20) be satisfied where W represents the field angle of the arbitrary imaging optical system constituting part of the multiple imaging optical systems, and Wn represents the field angle of the imaging optical system which is the next narrower field angle than the field angle W.

As described above, the multi-lens image capturing apparatus of this embodiment including the nine types of imaging optical systems whose field angles are different from one another makes it possible to realize the continuous zooming without requiring a zoom mechanism and the like. Furthermore, the image capturing apparatus of this embodiment includes the paired wide-angle imaging optical systems for image capturing of the widest object space among all the imaging optical systems and arranges the paired wide-angle imaging optical systems diagonally such that the base length therebetween is longest, thereby also achieving an improvement in accuracy in acquiring the distance information. That is, the configuration of this embodiment makes it possible to achieve an image-capturing apparatus, such as a video camera and a digital camera, having a reduced thickness and a high magnification ratio and being capable of easily acquiring accurate object side marginal space information for an object space to be captured.

Furthermore, description will be made of other marginal space information acquisition modes or marginal space information application modes in the image-capturing apparatuses 51, 62 and 73 configured as described above. In a high dynamic range mode, the apparatus performs image capturing through the imaging optical systems constituting the multiple lenses with mutually different exposure conditions and combines captured images to acquire information on a wide-dynamic-range image. In a blur-added mode, the apparatus adds blur to a background of the captured image on a basis of the object distance information calculated as described above to provide an image in which a main object is enhanced. In a background-removed mode, the apparatus provides an image in which a background other than the main object is removed on the basis of the object distance information calculated as described above. In a three-dimensional-object imaging mode, the apparatus acquires left and right parallax images by using the imaging optical systems arranged in the horizontal direction and constituting the multiple lenses. In this mode, the apparatus stores, as images for providing a three-dimensional image, one of the parallax images whose field angle is narrower than the other parallax image and a corresponding part of the other parallax image whose field angle is wider. Thus, the multi-lens image capturing apparatuses of Embodiments 5 to 7 can be each used as a three-dimensional image capturing apparatus.

In an image-capturing composition selection mode, the apparatus 51 displays multiple field angle images on the display unit 5200 as illustrated in FIG. 16 to allow the user to select a desired field angle image.

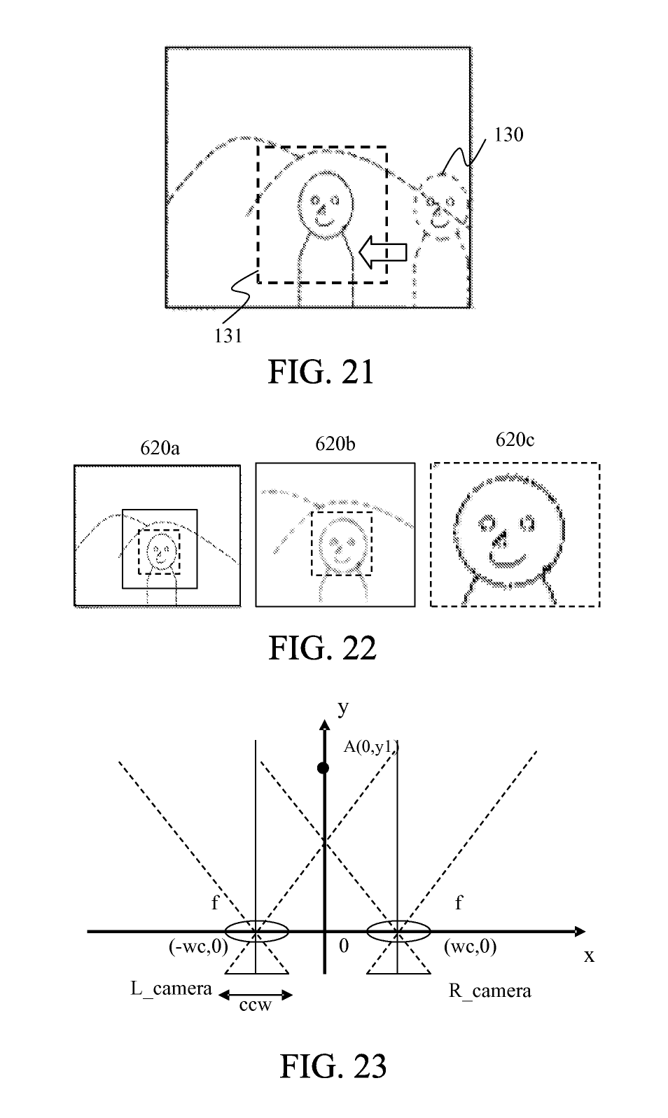

Next, a best shot mode will be briefly described with reference to FIG. 21. FIG. 21 illustrates an image within a field angle range corresponding to the imaging optical system 5101a of the multi-lens image capturing apparatus 51 and a dashed-line area 131 indicating a field angle range corresponding to the imaging optical system 5101b. In response to a user's operation to cause the multi-lens image capturing apparatus 51 to perform image capturing of a person 130, which is a moving object, at the field angle corresponding to the imaging optical system 5101b, the multi-lens image capturing apparatus 51 calculates a timing at which the moving object (person 130) enters the dashed-line area 131, by using the image processor S104. The timing can be calculated from the wide field angle image corresponding to the imaging optical system 5101a, by using a movement vector and the like of the moving object.

In an image-capturing area change mode, the apparatus 51 is configured such that the imaging optical systems are movable (shiftable) in a plane orthogonal to their optical axes. The apparatus 51 thereby changes object spaces corresponding to the imaging optical systems to store the captured images. As lust described, each of the multi-lens image capturing apparatuses of Embodiments 5 to 7 may include a shifter which shifts the multiple imaging optical systems in the plane orthogonal to their optical axes. For instance, shifting the telephoto imaging optical system 5101c makes it possible to enlarge and display an arbitrary partial area located in an image-capturing area corresponding to the imaging optical system 5101a.

Above-described Embodiments 5 to 7 makes it possible to provide a multi-lens image capturing apparatus having a reduced thickness and a high magnification ratio and being advantageous for acquiring the object side marginal space information on the object space to be captured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-241466, filed on Nov. 22, 2013 and Japanese Patent Application No. 2013-244844, filed on Nov. 27, 2013, which are hereby incorporated by reference herein in their entirety.

What is claimed is:

1. A multi-lens image capturing apparatus comprising:
multiple imaging optical systems arranged such that their optical axes are separate from one another in a direction orthogonal to the optical axes; and
an image capturing unit in which multiple image-capturing areas each performing image capturing of an object through a corresponding one of the imaging optical systems are provided,
wherein:
the multiple imaging optical systems include multiple first imaging optical systems each having a first field angle and at least one second imaging optical system having a second field angle wider than the first field angle, and
when viewed from a direction of the optical axes, the optical axis of the at least one second imaging optical system is located in a first area surrounded by lines connecting positions of the optical axes of the multiple first imaging optical systems.

2. A multi-lens image capturing apparatus according to claim 1,
wherein:
the multiple imaging optical systems include a multiple number of the second imaging optical systems, and
when viewed from the direction of the optical axes, the optical axis of at least one of the multiple second imaging optical systems is located in an area where the first area and a second area surrounded by lines connecting positions of the optical axes of the multiple second imaging optical systems overlap each other.

3. A multi-lens image capturing apparatus according to claim 2,
wherein:
the multiple imaging optical systems include multiple third imaging optical systems each having a third field angle wider than the first field angle and narrower than the second field angle, and
when viewed from the direction of the optical axes, the optical axis of the at least one second imaging optical system among the multiple second imaging optical systems is located in an area where the first area, the second area and a third area surrounded by lines connecting positions of the optical axes of the multiple third imaging optical systems overlap one another.

4. A multi-lens image capturing apparatus according to claim 1, further comprising an image combiner configured to combine, by using as a base image a whole or part of a captured image provided by image capturing through the second imaging optical system whose optical axis is located in the first area, captured images provided by image capturing through the first and second imaging optical systems.

5. A multi-lens image capturing apparatus according to claim 3, further comprising an image combiner configured to combine images provided by image capturing through the first, second and third imaging optical systems, by using as a base image a whole or part of a captured image provided by image capturing through the at least one second imaging optical system whose optical axis is located in the area where the first, second and third areas overlap one another.

6. A multi-lens image capturing apparatus according to claim 1, further comprising an image producer configured to produce, by using two captured images provided by image capturing through any two of the multiple imaging optical systems whose field angles are different from each other, an intermediate-field-angle image corresponding to an intermediate field angle between the field angles of the two imaging optical systems.

7. A multi-lens image capturing apparatus according to claim 1, wherein the apparatus is configured to display on a display device, as a preview image, a whole or part of a captured image provided by image capturing through the second imaging optical system whose optical axis is located in the first area.

8. A multi-lens image capturing apparatus according to claim 1, further comprising a distance calculator configured to calculate a distance to the object by using multiple captured images provided by image capturing through the multiple imaging optical systems and having parallax to one another.

9. A multi-lens image capturing apparatus according to claim 1, wherein, among the mutually different field angles of the multiple imaging optical systems, a field angle W and a next narrower field angle Wn than the field angle W satisfy a condition of:
1.1≦W/Wn≦3.

10. A multi-lens image capturing apparatus comprising:
multiple optical systems including (a) a first optical system and a second optical system each having a first field angle widest among those of the multiple optical systems and (b) a third optical system having a second field angle narrower than the first field angle; and
an image sensor having a first image-capturing area corresponding to the first optical system, a second image-capturing area corresponding to the second optical system and a third image-capturing area corresponding to the third optical system,
wherein:
the multiple optical systems are arranged such that the first and second optical systems have a longest base length therebetween among those between the multiple optical systems, and
the apparatus further comprises a calculator configured to calculate object distance information on a distance to an object contained in a first captured image provided from the first image-capturing area and in a second captured image provided from the second image-capturing area, by using the first and second captured images.

11. A multi-lens image capturing apparatus according to claim 10, further comprising an image producer configured to produce, by using the first captured image and a third captured image provided from the third image-capturing area, an intermediate-field-angle image corresponding to an intermediate field angle between the first and second field angles.

12. A multi-lens image capturing apparatus according to claim 10, wherein the multiple optical systems are arranged such that baselines connecting optical axes of the multiple optical systems intersect with one another.

13. A multi-lens image capturing apparatus according to claim 10, wherein the multiple optical systems include a fourth optical system having a third field angle narrower than the second field angle.

14. A multi-lens image capturing apparatus according to claim 10,
wherein:
the multiple optical systems are arranged such that baselines connecting optical axes of the multiple optical systems intersect with one another, and
the first and second optical systems are respectively arranged at diagonal vertex positions of a rectangular area where the multiple optical systems are arranged.

15. A multi-lens image capturing apparatus according to claim 11, wherein the image producer is configured to perform a super-resolution process to produce a higher resolution enlarged image than an enlarged image obtained by enlarging part of the first captured image by using the enlarged image and the third image.

16. A multi-lens image capturing apparatus according to claim 11, wherein the following condition is satisfied:
1.1<W/Wn<3
where W represents a field angle of any one of the multiple optical systems, and Wn represents a next narrower field angle than that of the one optical system.

17. A multi-lens image capturing apparatus according to claim 11, wherein optical axes of the multiple optical systems are parallel to one another.

18. A multi-lens image capturing apparatus according to claim 10, further comprising a shifter configured to shift each of the multiple optical systems in a plane orthogonal to optical axes of the multiple optical systems.
